(19) United States
(12) Patent Application Publication
(10) Pub. No.: US 2018/0359468 A1
(43) Pub. Date: Dec. 13, 2018

(54) IMAGE PROCESSING METHOD ON BASIS OF INTER PREDICTION MODE AND APPARATUS THEREFOR

(71) Applicant: LG ELECTRONICS INC., Seoul (KR)

(72) Inventors: Jungdong SEO, Seoul (KR); Jaehyun LIM, Seoul (KR); Naeri PARK, Seoul (US)

(21) Appl. No.: 15/765,167

(22) PCT Filed: Sep. 20, 2016
(86) PCT No.: PCT/KR2016/010973

§ 371 Date: Jul. 20, 2018

Related U.S. Application Data
(60) Provisional application No. 62/235,592, filed on Oct. 1, 2015.

(51) Int. Cl. H04N 19/105; H04N 19/593; H04N 19/59

(52) U.S. Cl. CPC H04N 19/105; H04N 19/59; H04N 19/593

(57) ABSTRACT

Disclosed are an image processing method on the basis of an inter prediction mode and an apparatus therefor. Specifically, a method for processing an image on the basis of inter prediction may comprise the steps of reducing the bit depth of a reconstructed picture and storing the same in a reference picture buffer; re-scaling the bit depth of a reference picture of a current block in the reconstructed picture stored in the reference picture buffer; and generating a prediction block for the current block on the basis of the reference picture, the bit depth of which has been re-scaled.

### CROSS-REFERENCE TO RELATED APPLICATIONS

This application is the National Stage filing under 35 U.S.C. 371 of International Application No. PCT/KR2016/010973, filed on Sep. 30, 2016, which claims the benefit of U.S. Provisional Application No. 62/235,592, filed on Oct. 1, 2015 the contents of which are all hereby incorporated by reference herein in their entirety.

### TECHNICAL FIELD

The present invention relates to a method of processing a still image or a moving image and, more particularly, to a method of encoding/decoding a still image or a moving image based on an inter-prediction mode and an apparatus supporting the same.

### BACKGROUND ART

Compression encoding means a series of signal processing techniques for transmitting digitized information through a communication line or techniques for storing information in a form suitable for a storage medium. The medium including a picture, an image, audio, etc. may be a target for compression encoding, and particularly, a technique for performing compression encoding on a picture is referred to as video image compression.

Next-generation video contents are supposed to have the characteristics of high spatial resolution, a high frame rate and high dimensionality of scene representation. In order to process such contents, a drastic increase in the memory storage, memory access rate and processing power will result.

Accordingly, it is required to design a coding tool for processing next-generation video contents efficiently.

### DISCLOSURE

### Technical Problem

The conventional still image or video compression technology performs inter-frame prediction (or inter prediction) through a motion prediction (or motion estimation) and motion compensation process. A motion compensation algorithm references pixel information of an area of a reference picture by taking into account a motion vector generated from the motion of objects in the picture. When the size of the reference picture is large, data bandwidth is increased. In particular, as services based on the UHD (Ultra-HD) video is widely accepted, and an input video generally has a bit depth of more than 10 bits, data bandwidth for motion compensation is greatly increased.

To solve the problem above, the present invention proposes a method for scaling the bit depth of a reference picture and storing the same.

Also, the present invention proposes a method for re-scaling the bit depth of a reference picture to perform inter prediction.

Also, the present invention proposes a method for re-scaling the bit depth of a reference picture in an interpolation filtering process.

Technical objects to be achieved by the present invention are not limited to the aforementioned technical objects, and other technical objects not described above may be evidently understood by a person having ordinary skill in the art to which the present invention pertains from the following description.

### Technical Solution

According to one aspect of the present invention, a method for processing an image based on inter prediction includes scaling a bit depth of a reconstructed picture and storing the reconstructed picture in a reference picture buffer; re-scaling the bit depth of the reference picture of a current block among the reconstructed pictures stored in the reference picture buffer; and generating a prediction block for the current block based on the reference picture in which the bit depth is re-scaled.

According to one aspect of the present invention, an apparatus for processing an image on the basis of inter prediction includes a bit depth scaling unit scaling the bit depth of a reconstructed picture and storing the same in a reference picture buffer; a bit depth re-scaling unit re-scaling the bit depth of a reference picture of a current block in the reconstructed picture stored in the reference picture buffer; and a prediction block generating unit generating a prediction block for the current block on the basis of the reference picture, the bit depth of which has been re-scaled.

Preferably, the bit depth of the reconstructed picture may be scaled by removing a specific number of least significant bits (LSBs) from each sample value of the reconstructed picture.

Preferably, the bit depth of the reference picture may be re-scaled by inserting as many zeros as the number of removed bits to the LSBs of each sample value of the reference picture.

Preferably, the bit depth of the reference picture may be re-scaled by inserting the middle value of removed bits to the LSBs of each sample value of the reference picture.

Preferably, the bit depth of the reference picture may be re-scaled by inserting as many random values as the number of removed bits to the LSBs of each sample value of the reference picture.

Preferably, the bit depth of the reconstructed picture may be scaled by applying a transform function to each sample value of the reconstructed picture.

Preferably, the bit depth of the reconstructed picture may be re-scaled by applying an inverse transform function having an inverse relationship with the transform function to each sample value of the reference picture.

Preferably, information about a method for scaling/re-scaling the bit depth may be predetermined or signaled by an encoder in units of sequences, pictures, slices, or blocks.

Preferably, the re-scaling the bit depth may re-scale the bit depth of the reference block before interpolation filtering is performed on a reference block designated by motion information of the current block in the reference picture, wherein the prediction block for the current block may be generated on the basis of the reference block the bit depth of which has been re-scaled.

Preferably, the re-scaling the bit depth may re-scale the bit depth of the reference block after interpolation filtering is performed on a reference block designated by motion information of the current block in the reference picture, wherein the prediction block for the current block may be generated on the basis of a reference block the bit depth of which has been re-scaled.

Preferably, the re-scaling the bit depth may re-scale the bit depth of the reference block while interpolation filtering is performed on a reference block designated by motion information of the current block in the reference picture, wherein the prediction block for the current block may be generated on the basis of a reference block the bit depth of which has been re-scaled.

### Advantageous Effects

According to an embodiment of the present invention, storage space for a reference picture may be reduced by scaling the bit depth of the reference picture and storing the same.

Also, according to an embodiment of the present invention, data bandwidth for predicting/compensating motion occurring frequently during an encoding/decoding process of an image may be reduced.

Technical effects which may be obtained in the present invention are not limited to the technical effects described above, and other technical effects not mentioned herein may be understood to those skilled in the art from the description below.

### DESCRIPTION OF DRAWINGS

The accompanying drawings, which are included herein as a part of the description for help understanding the present invention, provide embodiments of the present invention, and describe the technical features of the present invention with the description below.

FIG. 1 illustrates a schematic block diagram of an encoder in which the encoding of a still image or video signal is performed, as an embodiment to which the present invention is applied.

FIG. 2 illustrates a schematic block diagram of a decoder in which decoding of a still image or video signal is performed, as an embodiment to which the present invention is applied.

FIG. 3 is a diagram for describing a split structure of a coding unit that may be applied to the present invention.

FIG. 4 is a diagram for describing a prediction unit that may be applied to the present invention.

FIG. 5 is an embodiment to which the present invention may be applied and is a diagram illustrating the direction of inter-prediction.

FIG. 6 is an embodiment to which the present invention may be applied and illustrates integers for ¼ sample interpolation and fractional sample locations.

FIG. 7 is an embodiment to which the present invention may be applied and illustrates the location of a spatial candidate.

FIG. 8 is an embodiment to which the present invention is applied and is a diagram illustrating an inter-prediction method.

FIG. 9 is an embodiment to which the present invention may be applied and is a diagram illustrating a motion compensation process.

FIG. 10 illustrates a block diagram of an encoder according to one embodiment of the present invention.

FIG. 11 illustrates a block diagram of a decoder according to one embodiment of the present invention.

FIG. 12 illustrates a method for processing an image on the basis of inter prediction according to one embodiment of the present invention.

FIG. 13 illustrates a method for processing an image on the basis of inter prediction according to one embodiment of the present invention.

FIG. 14 illustrates a method for scaling bit depth according to one embodiment of the present invention.

FIG. 15 illustrates a method for scaling bit depth according to one embodiment of the present invention.

FIG. 16 illustrates a linear transform function according to one embodiment of the present invention.

FIG. 17 illustrates a method for scaling bit depth according to one embodiment of the present invention.

FIG. 18 illustrates a nonlinear transform function according to one embodiment of the present invention.

FIG. 19 illustrates a method for re-scaling bit depth according to one embodiment of the present invention.

FIG. 20 illustrates a method for re-scaling bit depth according to one embodiment of the present invention.

FIG. 21 illustrates a block diagram of an encoder according to one embodiment of the present invention.

FIG. 22 illustrates a block diagram of a decoder according to one embodiment of the present invention.

FIG. 23 illustrates a method for processing an image on the basis of inter prediction according to one embodiment of the present invention.

FIG. 24 illustrates an encoding/decoding apparatus according to one embodiment of the present invention.

### MODE FOR INVENTION

Hereinafter, a preferred embodiment of the present invention will be described by reference to the accompanying drawings. The description that will be described below with the accompanying drawings is to describe exemplary embodiments of the present invention, and is not intended to describe the only embodiment in which the present invention may be implemented. The description below includes particular details in order to provide perfect understanding of the present invention. However, it is understood that the present invention may be embodied without the particular details to those skilled in the art.

In some cases, in order to prevent the technical concept of the present invention from being unclear, structures or devices which are publicly known may be omitted, or may be depicted as a block diagram centering on the core functions of the structures or the devices.

Further, although general terms widely used currently are selected as the terms in the present invention as much as possible, a term that is arbitrarily selected by the applicant is used in a specific case. Since the meaning of the term will be clearly described in the corresponding part of the description in such a case, it is understood that the present invention will not be simply interpreted by the terms only used in the description of the present invention, but the meaning of the terms should be figured out.

Specific terminologies used in the description below may be provided to help the understanding of the present invention. Furthermore, the specific terminology may be modified into other forms within the scope of the technical concept of the present invention. For example, a signal, data, a sample, a picture, a frame, a block, etc may be properly replaced and interpreted in each coding process.

Hereinafter, in this specification, a “processing unit” means a unit in which an encoding/decoding processing process, such as prediction, transform and/or quantization, is performed. Hereinafter, for convenience of description, a processing unit may also be called a “unit”, “processing block” or “block.”

A processing unit may be construed as having a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as being a unit for a luma component or a unit for a chroma component. For example, the processing unit may correspond to a coding tree block (CTB), coding block (CB), prediction block (PB) or transform block (TB) for a luma component. Alternatively, a processing unit may correspond to a coding tree block (CTB), coding block (CB), prediction block (PB) or transform block (TB) for a chroma component. Also, the present invention is not limited to the description above, and the processing unit may also be construed as including a unit for a luma component or a unit for a chroma component.

Furthermore, a processing unit is not essentially limited to a square block and may be constructed in a polygon form having three or more vertices.

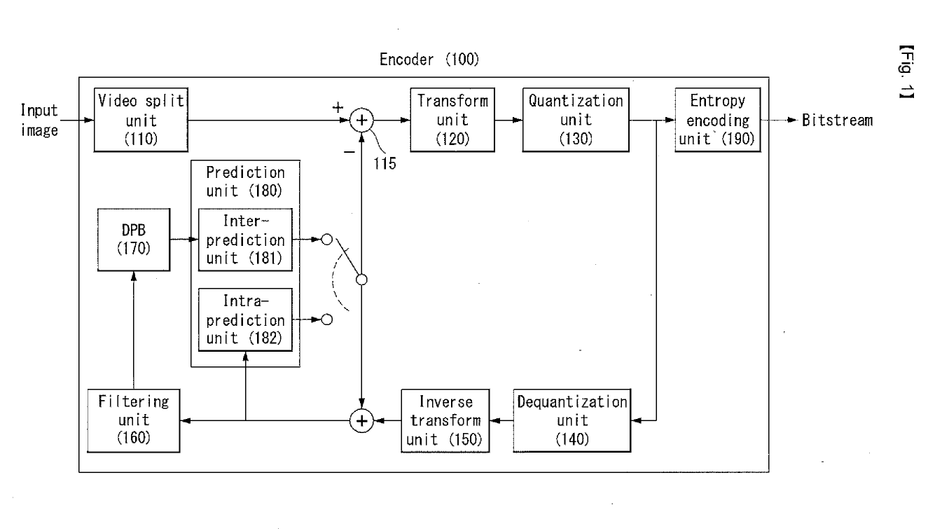

FIG. 1 illustrates a schematic block diagram of an encoder in which the encoding of a still image or video signal is performed, as an embodiment to which the present invention is applied.

Referring to FIG. 1, the encoder 100 may include a video split unit 110, a subtractor 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., by the inter-prediction unit 181 or the intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate transform coefficients by performing transform using a prediction mode applied to the residual block and a transform scheme determined based on the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal outputted by the quantization unit 130 may be used to generate a prediction signal. For example, a residual signal may be reconstructed by applying dequantization and inverse transformation to the quantized signal through the dequantization unit 140 and the inverse transform unit 150. A reconstructed signal may be generated by adding the reconstructed residual signal to the prediction signal output by the inter-prediction unit 181 or the intra-prediction unit 182.

Meanwhile, during such a compression process, neighbor blocks are quantized by different quantization parameters. Accordingly, an artifact in which a block boundary is shown may occur. Such a phenomenon is referred to a blocking artifact, which is one of important factors for evaluating image quality. In order to decrease such an artifact, a filtering process may be performed. Through such a filtering process, the blocking artifact is removed and the error of a current picture is decreased at the same time, thereby improving image quality.

The filtering unit 160 applies filtering to the reconstructed signal, and outputs it through a playback device or transmits it to the decoded picture buffer 170. The filtered signal transmitted to the decoded picture buffer 170 may be used as a reference picture in the inter-prediction unit 181. As described above, an encoding rate as well as image quality can be improved using the filtered picture as a reference picture in an inter-picture prediction mode.

The decoded picture buffer 170 may store the filtered picture in order to use it as a reference picture in the inter-prediction unit 181.

The inter-prediction unit 181 performs temporal prediction and/or spatial prediction with reference to the reconstructed picture in order to remove temporal redundancy and/or spatial redundancy.

In this case, a blocking artifact or ringing artifact may occur because a reference picture used to perform prediction is a transformed signal that experiences quantization or dequantization in a block unit when it is encoded/decoded previously.

Accordingly, in order to solve performance degradation attributable to the discontinuity of such a signal or quantization, signals between pixels may be interpolated in a sub-pixel unit by applying a low pass filter to the inter-prediction unit 181. In this case, the sub-pixel means a virtual pixel generated by applying an interpolation filter, and an integer pixel means an actual pixel that is present in a reconstructed picture. A linear interpolation, a bi-linear interpolation, a wiener filter, and the like may be applied as an interpolation method.

The interpolation filter may be applied to the reconstructed picture, and may improve the accuracy of prediction. For example, the inter-prediction unit 181 may perform prediction by generating an interpolation pixel by applying the interpolation filter to the integer pixel and by using the interpolated block including interpolated pixels as a prediction block.

The intra-prediction unit 182 predicts a current block with reference to samples neighboring the block that is now to be encoded. The intra-prediction unit 182 may perform the following procedure in order to perform intra-prediction. First, the intra-prediction unit 182 may prepare a reference sample necessary to generate a prediction signal. Furthermore, the intra-prediction unit 182 may generate a prediction signal using the prepared reference sample. Next, the intra-prediction unit 182 may encode a prediction mode. In this case, the reference sample may be prepared through reference sample padding and/or reference sample filtering. A quantization error may be present because the reference sample experiences the prediction and the reconstruction process. Accordingly, in order to reduce such an error, a reference sample filtering process may be performed on each prediction mode used for the intra-prediction.

The prediction signal (or prediction block) generated through the inter-prediction unit 181 or the intra-prediction unit 182 may be used to generate a reconstructed signal (or reconstructed block) or may be used to generate a residual signal (or residual block).

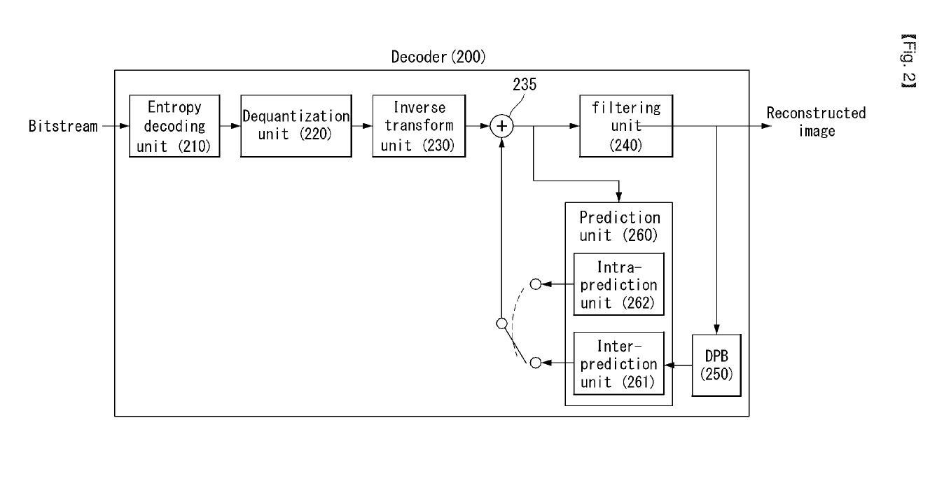

FIG. 2 illustrates a schematic block diagram of a decoder in which decoding of a still image or video signal is performed, as an embodiment to which the present invention is applied.

Referring to FIG. 2, the decoder 200 may include an entropy decoding unit 210, a dequantization unit 220, an inverse transform unit 230, an adder 235, a filtering unit 240, a decoded picture buffer (DPB) 250 and a prediction unit 260. Furthermore, the prediction unit 260 may include an inter-prediction unit 261 and an intra-prediction unit 262.

Furthermore, a reconstructed video signal output through the decoder 200 may be played back through a playback device.

The decoder 200 receives a signal (i.e., bit stream) output by the encoder 100 shown in FIG. 1. The entropy decoding unit 210 performs an entropy decoding operation on the received signal.

The dequantization unit 220 obtains transform coefficients from the entropy-decoded signal using quantization step size information.

The inverse transform unit 230 obtains a residual signal (or residual block) by inverse transforming the transform coefficients by applying an inverse transform scheme.

The adder 235 adds the obtained residual signal (or residual block) to the prediction signal (or prediction block) output by the prediction unit 260 (i.e., the inter-prediction unit 261 or the intra-prediction unit 262), thereby generating a reconstructed signal (or reconstructed block).

The filtering unit 240 applies filtering to the reconstructed signal (or reconstructed block) and outputs the filtered signal to a playback device or transmits the filtered signal to the decoded picture buffer 250. The filtered signal transmitted to the decoded picture buffer 250 may be used as a reference picture in the inter-prediction unit 261.

In this specification, the embodiments described in the filtering unit 160, inter-prediction unit 181 and intra-prediction unit 182 of the encoder 100 may be identically applied to the filtering unit 240, inter-prediction unit 261 and intra-prediction unit 262 of the decoder, respectively.

Processing Unit Split Structure

In general, a block-based image compression method is used in the compression technique (e.g., HEVC) of a still image or a video. The block-based image compression method is a method of processing an image by splitting it into specific block units, and may decrease memory use and a computational load.

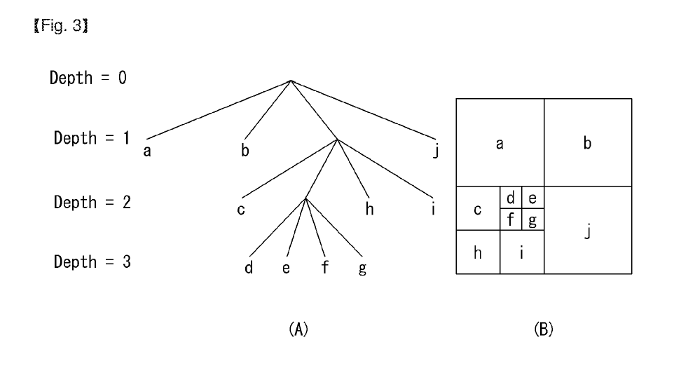

FIG. 3 is a diagram for describing a split structure of a coding unit which may be applied to the present invention.

An encoder splits a single image (or picture) into coding tree units (CTUs) of a quadrangle form, and sequentially encodes the CTUs one by one according to raster scan order.

In HEVC, a size of CTU may be determined as one of 64×64, 32×32, and 16×16. The encoder may select and use the size of a CTU based on resolution of an input video signal or the characteristics of input video signal. The CTU includes a coding tree block (CTB) for a luma component and the CTB for two chroma components that correspond to it.

One CTU may be split in a quad-tree structure. That is, one CTU may be split into four units each having a square form and having a half horizontal size and a half vertical size, thereby being capable of generating coding units (CUs). Such splitting of the quad-tree structure may be recursively performed. That is, the CUs are hierarchically split from one CTU in the quad-tree structure.

A CU means a basic unit for the processing process of an input video signal, for example, coding in which intra/inter prediction is performed. A CU includes a coding block (CB) for a luma component and a CB for two chroma components corresponding to the luma component. In HEVC, a CU size may be determined as one of 64×64, 32×32, 16×16, and 8×8.

Referring to FIG. 3, the root node of a quad-tree is related to a CTU. The quad-tree is split until a leaf node is reached. The leaf node corresponds to a CU.

This is described in more detail. The CTU corresponds to the root node and has the smallest depth (i.e., depth=0) value. A CTU may not be split depending on the characteristics of an input video signal. In this case, the CTU corresponds to a CU.

A CTU may be split in a quad-tree form. As a result, lower nodes, that is, a depth 1 (depth=1), are generated. Furthermore, a node (i.e., leaf node) that belongs to the lower nodes having the depth of 1 and that is no longer split corresponds to a CU. For example, in FIG. 3(b), a CU(a), a CU(b) and a CU(j) corresponding to nodes a, b and j have been once split from the CTU, and have a depth of 1.

At least one of the nodes having the depth of 1 may be split in a quad-tree form. As a result, lower nodes having a depth 1 (i.e., depth=2) are generated. Furthermore, a node (i.e., leaf node) that belongs to the lower nodes having the depth of 2 and that is no longer split corresponds to a CU. For example, in FIG. 3(b), a CU(c), a CU(h) and a CU(i) corresponding to nodes c, h and i have been twice split from the CTU, and have a depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a CU(d), a CU(e), a CU(f) and a CU(g) corresponding to nodes d, e, f and g have been three times split from the CTU, and have a depth of 3.

In the encoder, a maximum size or minimum size of a CU may be determined based on the characteristics of a video image (e.g., resolution) or by considering the encoding rate. Furthermore, information about the maximum or minimum size or information capable of deriving the information may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents a split count and/or degree of a CU, it may include information about the size of a CU.

Since the LCU is split in a Quad-tree shape, the size of SCU may be obtained by using a size of LCU and the maximum depth information. Or, inversely, the size of LCU may be obtained by using a size of SCU and the maximum depth information of the tree.

For a single CU, the information (e.g., a split CU flag (split_cu_flag)) that represents whether the corresponding CU is split may be forwarded to the decoder. This split information is included in all CUs except the SCU. For example, when the value of the flag that represents whether to split is ‘1’, the corresponding CU is further split into four CUs, and when the value of the flag that represents whether to split is ‘0’, the corresponding CU is not split any more, and the processing process for the corresponding CU may be performed.

As described above, a CU is a basic unit of the coding in which the intra-prediction or the inter-prediction is performed. The HEVC splits the CU in a prediction unit (PU) for coding an input video signal more effectively.

A PU is a basic unit for generating a prediction block, and even in a single CU, the prediction block may be generated in different way by a unit of PU. However, the intra-prediction and the inter-prediction are not used together for the PUs that belong to a single CU, and the PUs that belong to a single CU are coded by the same prediction method (i.e., the intra-prediction or the inter-prediction).

A PU is not split in the Quad-tree structure, but is split once in a single CU in a predetermined shape. This will be described by reference to the drawing below.

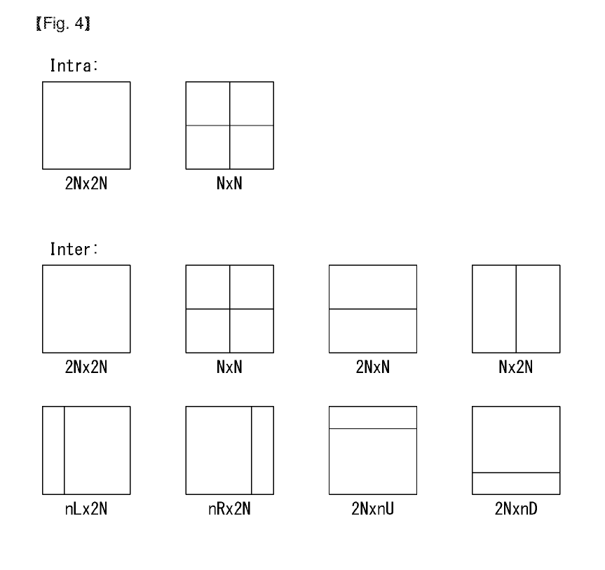

FIG. 4 is a diagram for describing a prediction unit that may be applied to the present invention.

A PU is differently split depending on whether the intra-prediction mode is used or the inter-prediction mode is used as the coding mode of the CU to which the PU belongs.

FIG. 4(a) illustrates a PU if the intra-prediction mode is used, and FIG. 4(b) illustrates a PU if the inter-prediction mode is used.

Referring to FIG. 4(a), assuming that the size of a single CU is 2N×2N (N=4, 8, 16 and 32), the single CU may be split into two types (i.e., 2N×2N or N×N).

In this case, if a single CU is split into the PU of 2N×2N shape, it means that only one PU is present in a single CU.

Meanwhile, if a single CU is split into the PU of N×N shape, a single CU is split into four PUs, and different prediction blocks are generated for each PU unit. However, such PU splitting may be performed only if the size of CB for the luma component of CU is the minimum size (i.e., the case that a CU is an SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in the intra-prediction, the PU split of N×N shape may be performed only if the size of CB for the luma component of CU is the minimum size (i.e., the case that a CU is an SCU).

The inter-prediction supports the PU split in the shape of 2N×N that is split in a horizontal direction and in the shape of N×2N that is split in a vertical direction.

In addition, the inter-prediction supports the PU split in the shape of nL×2N, nR×2N, 2N×nU and 2N×nD, which is an asymmetric motion split (AMP). In this case, ‘n’ means ¼ value of 2N. However, the AMP may not be used if the CU to which the PU is belonged is the CU of minimum size.

In order to encode the input video signal in a single CTU efficiently, the optimal split structure of the coding unit (CU), the prediction unit (PU) and the transform unit (TU) may be determined based on a minimum rate-distortion value through the processing process as follows. For example, as for the optimal CU split process in a 64×64 CTU, the rate-distortion cost may be calculated through the split process from a CU of 64×64 size to a CU of 8×8 size. The detailed process is as follows.

1) The optimal split structure of a PU and TU that generates the minimum rate distortion value is determined by performing inter/intra-prediction, transformation/quantization, dequantization/inverse transformation and entropy encoding on the CU of 64×64 size.

2) The optimal split structure of a PU and TU is determined to split the 64×64 CU into four CUs of 32×32 size and to generate the minimum rate distortion value for each 32×32 CU.

3) The optimal split structure of a PU and TU is determined to further split the 32×32 CU into four CUs of 16×≠size and to generate the minimum rate distortion value for each 16×≠CU.

4) The optimal split structure of a PU and TU is determined to further split the 16×≠CU into four CUs of 8×8 size and to generate the minimum rate distortion value for each 8×8 CU.

5) The optimal split structure of a CU in the 16×≠block is determined by comparing the rate-distortion value of the 16×≠CU obtained in the process 3) with the addition of the rate-distortion value of the four 8×8 CUs obtained in the process 4). This process is also performed for remaining three 16×≠CUs in the same manner.

6) The optimal split structure of CU in the 32×32 block is determined by comparing the rate-distortion value of the 32×32 CU obtained in the process 2) with the addition of the rate-distortion value of the four 16×≠CUs that is obtained in the process 5). This process is also performed for remaining three 32×32 CUs in the same manner.

7) Finally, the optimal split structure of CU in the 64×64 block is determined by comparing the rate-distortion value of the 64×64 CU obtained in the process 1) with the addition of the rate-distortion value of the four 32×32 CUs obtained in the process 6).

In the intra-prediction mode, a prediction mode is selected as a PU unit, and prediction and reconstruction are performed on the selected prediction mode in an actual TU unit.

A TU means a basic unit in which actual prediction and reconstruction are performed. A TU includes a transform block (TB) for a luma component and a TB for two chroma components corresponding to the luma component.

In the example of FIG. 3, as in an example in which one CTU is split in the quad-tree structure to generate a CU, a TU is hierarchically split from one CU to be coded in the quad-tree structure.

TUs split from a CU may be split into smaller and lower TUs because a TU is split in the quad-tree structure. In HEVC, the size of a TU may be determined to be as one of 32×32, 16×16, 8×8 and 4×4.

Referring back to FIG. 3, the root node of a quad-tree is assumed to be related to a CU. The quad-tree is split until a leaf node is reached, and the leaf node corresponds to a TU.

This is described in more detail. A CU corresponds to a root node and has the smallest depth (i.e., depth=0) value. A CU may not be split depending on the characteristics of an input image. In this case, the CU corresponds to a TU.

A CU may be split in a quad-tree form. As a result, lower nodes having a depth 1 (depth=1) are generated. Furthermore, a node (i.e., leaf node) that belongs to the lower nodes having the depth of 1 and that is no longer split corresponds to a TU. For example, in FIG. 3(b), a TU(a), a TU(b) and a TU(j) corresponding to the nodes a, b and j are once split from a CU and have a depth of 1.

At least one of the nodes having the depth of 1 may be split in a quad-tree form again. As a result, lower nodes having a depth 2 (i.e., depth=2) are generated. Furthermore, a node (i.e., leaf node) that belongs to the lower nodes having the depth of 2 and that is no longer split corresponds to a TU. For example, in FIG. 3(b), a TU(c), a TU(h) and a TU(i) corresponding to the node c, h and l have been split twice from the CU and have the depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a TU(d), a TU(e), a TU(f) and a TU(g) corresponding to the nodes d, e, f and g have been three times split from the CU and have the depth of 3.

A TU having a tree structure may be hierarchically split with predetermined maximum depth information (or maximum level information). Furthermore, each spit TU may have depth information. The depth information may include information about the size of the TU because it indicates the split number and/or degree of the TU.

Information (e.g., a split TU flag “split_transform_flag”) indicating whether a corresponding TU has been split with respect to one TU may be transferred to the decoder. The split information is included in all of TUs other than a TU of a minimum size. For example, if the value of the flag indicating whether a TU has been split is “1”, the corresponding TU is split into four TUs. If the value of the flag indicating whether a TU has been split is “0”, the corresponding TU is no longer split.

Prediction

In order to reconstruct a current processing unit on which decoding is performed, the decoded part of a current picture or other pictures including the current processing unit may be used.

A picture (slice) using only a current picture for reconstruction, that is, on which only intra-prediction is performed, may be called an intra-picture or I picture (slice), a picture (slice) using a maximum of one motion vector and reference index in order to predict each unit may be called a predictive picture or P picture (slice), and a picture (slice) using a maximum of two motion vector and reference indices may be called a bi-predictive picture or B a picture (slice).

Intra-prediction means a prediction method of deriving a current processing block from the data element (e.g., a sample value) of the same decoded picture (or slice). That is, intra-prediction means a method of predicting the pixel value of a current processing block with reference to reconstructed regions within a current picture.

Hereinafter, inter-prediction is described in more detail.

Inter-Prediction (or Inter-Frame Prediction)

Inter-prediction means a prediction method of deriving a current processing block based on the data element (e.g., sample value or motion vector) of a picture other than a current picture. That is, inter-prediction means a method of predicting the pixel value of a current processing block with reference to reconstructed regions within another reconstructed picture other than a current picture.

Inter-prediction (or inter-picture prediction) is a technology for removing redundancy present between pictures and is chiefly performed through motion estimation and motion compensation.

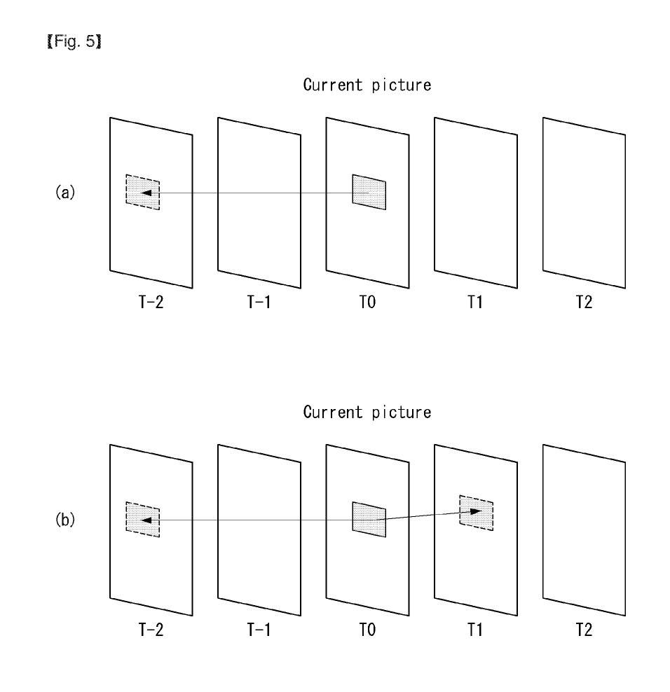

FIG. 5 is an embodiment to which the present invention may be applied and is a diagram illustrating the direction of inter-prediction.

Referring to FIG. 5, inter-prediction may be divided into uni-direction prediction in which only one past picture or future picture is used as a reference picture on a time axis with respect to a single block and bi-directional prediction in which both the past and future pictures are referred at the same time.

Furthermore, the uni-direction prediction may be divided into forward direction prediction in which a single reference picture temporally displayed (or output) prior to a current picture is used and backward direction prediction in which a single reference picture temporally displayed (or output) after a current picture is used.

In the inter-prediction process (i.e., uni-direction or bi-directional prediction), a motion parameter (or information) used to specify which reference region (or reference block) is used in predicting a current block includes an inter-prediction mode (in this case, the inter-prediction mode may indicate a reference direction (i.e., uni-direction or bidirectional) and a reference list (i.e., L0, L1 or bidirectional)), a reference index (or reference picture index or reference list index), and motion vector information. The motion vector information may include a motion vector, motion vector prediction (MVP) or a motion vector difference (MVD). The motion vector difference means a difference between a motion vector and a motion vector predictor.

In the uni-direction prediction, a motion parameter for one-side direction is used. That is, one motion parameter may be necessary to specify a reference region (or reference block).

In the bi-directional prediction, a motion parameter for both directions is used. In the bi-directional prediction method, a maximum of two reference regions may be used. The two reference regions may be present in the same reference picture or may be present in different pictures. That is, in the bi-directional prediction method, a maximum of two motion parameters may be used. Two motion vectors may have the same reference picture index or may have different reference picture indices. In this case, the reference pictures may be displayed temporally prior to a current picture or may be displayed (or output) temporally after a current picture.

The encoder performs motion estimation in which a reference region most similar to a current processing block is searched for in reference pictures in an inter-prediction process. Furthermore, the encoder may provide the decoder with a motion parameter for a reference region.

The encoder/decoder may obtain the reference region of a current processing block using a motion parameter. The reference region is present in a reference picture having a reference index. Furthermore, the pixel value or interpolated value of a reference region specified by a motion vector may be used as the predictor of a current processing block. That is, motion compensation in which an image of a current processing block is predicted from a previously decoded picture is performed using motion information.

In order to reduce the transfer rate related to motion vector information, a method of obtaining a motion vector predictor (mvd) using motion information of previously decoded blocks and transmitting only the corresponding difference (mvd) may be used. That is, the decoder calculates the motion vector predictor of a current processing block using motion information of other decoded blocks and obtains a motion vector value for the current processing block using a difference from the encoder. In obtaining the motion vector predictor, the decoder may obtain various motion vector candidate values using motion information of other already decoded blocks, and may obtain one of the various motion vector candidate values as a motion vector predictor.

Reference Picture Set and Reference Picture List

In order to manage multiple reference pictures, a set of previously decoded pictures are stored in the decoded picture buffer (DPB) for the decoding of the remaining pictures.

A reconstructed picture that belongs to reconstructed pictures stored in the DPB and that is used for inter-prediction is called a reference picture. In other words, a reference picture means a picture including a sample that may be used for inter-prediction in the decoding process of a next picture in a decoding sequence.

A reference picture set (RPS) means a set of reference pictures associated with a picture, and includes all of previously associated pictures in the decoding sequence. A reference picture set may be used for the inter-prediction of an associated picture or a picture following a picture in the decoding sequence. That is, reference pictures retained in the decoded picture buffer (DPB) may be called a reference picture set. The encoder may provide the decoder with a sequence parameter set (SPS) (i.e., a syntax structure having a syntax element) or reference picture set information in each slice header.

A reference picture list means a list of reference pictures used for the inter-prediction of a P picture (or slice) or a B picture (or slice). In this case, the reference picture list may be divided into two reference pictures lists, which may be called a reference picture list 0 (or L0) and a reference picture list 1 (or L1). Furthermore, a reference picture belonging to the reference picture list 0 may be called a reference picture 0 (or L0 reference picture), and a reference picture belonging to the reference picture list 1 may be called a reference picture 1 (or L1 reference picture).

In the decoding process of the P picture (or slice), one reference picture list (i.e., the reference picture list 0). In the decoding process of the B picture (or slice), two reference pictures lists (i.e., the reference picture list 0 and the reference picture list 1) may be used. Information for distinguishing between such reference picture lists for each reference picture may be provided to the decoder through reference picture set information. The decoder adds a reference picture to the reference picture list 0 or the reference picture list 1 based on reference picture set information.

In order to identify any one specific reference picture within a reference picture list, a reference picture index (or reference index) is used.

Fractional Sample Interpolation

A sample of a prediction block for an inter-predicted current processing block is obtained from the sample value of a corresponding reference region within a reference picture identified by a reference picture index. In this case, a corresponding reference region within a reference picture indicates the region of a location indicated by the horizontal component and vertical component of a motion vector. Fractional sample interpolation is used to generate a prediction sample for non-integer sample coordinates except a case where a motion vector has an integer value. For example, a motion vector of ¼ scale of the distance between samples may be supported.

In the case of HEVC, fractional sample interpolation of a luma component applies an 8 tab filter in the traverse direction and longitudinal direction. Furthermore, the fractional sample interpolation of a chroma component applies a 4 tab filter in the traverse direction and the longitudinal direction.

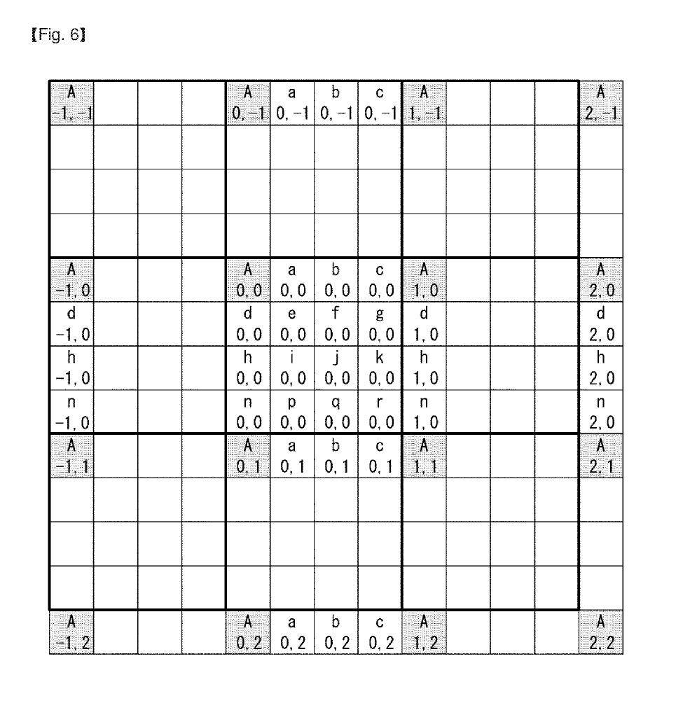

FIG. 6 is an embodiment to which the present invention may be applied and illustrates integers for ¼ sample interpolation and a fraction sample locations.

Referring to FIG. 6, a shadow block in which an upper-case letter (A_i,j) is written indicates an integer sample location, and a block not having a shadow in which a lower-case letter (x_i,j) is written indicates a fraction sample location.

A fraction sample is generated by applying an interpolation filter to an integer sample value in the horizontal direction and the vertical direction. For example, in the case of the horizontal direction, the 8 tab filter may be applied to four integer sample values on the left side and four integer sample values on the right side based on a fraction sample to be generated.

Inter-Prediction Mode

In HEVC, in order to reduce the amount of motion information, a merge mode and advanced motion vector prediction (AMVP) may be used.

1) Merge Mode

The merge mode means a method of deriving a motion parameter (or information) from a spatially or temporally neighbor block.

In the merge mode, a set of available candidates includes spatially neighboring candidates, temporal candidates and generated candidates.

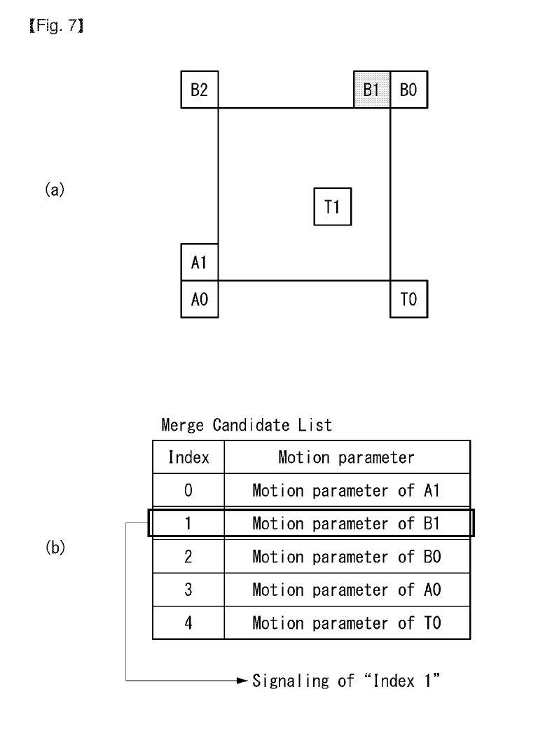

FIG. 7 is an embodiment to which the present invention may be applied and illustrates the location of a spatial candidate.

Referring to FIG. 7(a), whether each spatial candidate block is available depending on the sequence of {A1, B1, B0, A0, B2} is determined. In this case, if a candidate block is not encoded in the intra-prediction mode and motion information is present or if a candidate block is located out of a current picture (or slice), the corresponding candidate block cannot be used.

After the validity of a spatial candidate is determined, a spatial merge candidate may be configured by excluding an unnecessary candidate block from the candidate block of a current processing block. For example, if the candidate block of a current prediction block is a first prediction block within the same coding block, candidate blocks having the same motion information other than a corresponding candidate block may be excluded.

When the spatial merge candidate configuration is completed, a temporal merge candidate configuration process is performed in order of {T0, T1}.

In a temporal candidate configuration, if the right bottom block T0 of a collocated block of a reference picture is available, the corresponding block is configured as a temporal merge candidate. The collocated block means a block present in a location corresponding to a current processing block in a selected reference picture. In contrast, if not, a block T1 located at the center of the collocated block is configured as a temporal merge candidate.

A maximum number of merge candidates may be specified in a slice header. If the number of merge candidates is greater than the maximum number, a spatial candidate and temporal candidate having a smaller number than the maximum number are maintained. If not, the number of additional merge candidates (i.e., combined bi-predictive merging candidates) is generated by combining candidates added so far until the number of candidates becomes the maximum number.

The encoder configures a merge candidate list using the above method, and signals candidate block information, selected in a merge candidate list by performing motion estimation, to the decoder as a merge index (e.g., merge_idx[x0][y0]′). FIG. 7(b) illustrates a case where a B1 block has been selected from the merge candidate list. In this case, an “index 1 (Index 1)” may be signaled to the decoder as a merge index.

The decoder configures a merge candidate list like the encoder, and derives motion information about a current prediction block from motion information of a candidate block corresponding to a merge index from the encoder in the merge candidate list. Furthermore, the decoder generates a prediction block for a current processing block based on the derived motion information (i.e., motion compensation).

2) Advanced Motion Vector Prediction (AMVP) Mode

The AMVP mode means a method of deriving a motion vector prediction value from a neighbor block. Accordingly, a horizontal and vertical motion vector difference (MVD), a reference index and an inter-prediction mode are signaled to the decoder. Horizontal and vertical motion vector values are calculated using the derived motion vector prediction value and a motion vector difference (MVDP) provided by the encoder.

That is, the encoder configures a motion vector predictor candidate list, and signals a motion reference flag (i.e., candidate block information) (e.g., mvp_IX_flag[x0][y0]′), selected in motion vector predictor candidate list by performing motion estimation, to the decoder. The decoder configures a motion vector predictor candidate list like the encoder, and derives the motion vector predictor of a current processing block using motion information of a candidate block indicated by a motion reference flag received from the encoder in the motion vector predictor candidate list. Furthermore, the decoder obtains a motion vector value for the current processing block using the derived motion vector predictor and a motion vector difference transmitted by the encoder. Furthermore, the decoder generates a prediction block for the current processing block based on the derived motion information (i.e., motion compensation).

In the case of the AMVP mode, two spatial motion candidates of the five available candidates in FIG. 7 are selected. The first spatial motion candidate is selected from a {A0, A1} set located on the left side, and the second spatial motion candidate is selected from a {B0, B1, B2} set located at the top. In this case, if the reference index of a neighbor candidate block is not the same as a current prediction block, a motion vector is scaled.

If the number of candidates selected as a result of search for spatial motion candidates is 2, a candidate configuration is terminated. If the number of selected candidates is less than 2, a temporal motion candidate is added.

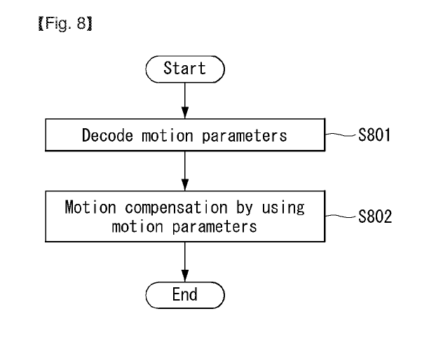

FIG. 8 is an embodiment to which the present invention is applied and is a diagram illustrating an inter-prediction method.

Referring to FIG. 8, the decoder (in particular, the inter-prediction unit 261 of the decoder in FIG. 2) decodes a motion parameter for a processing block (e.g., a prediction unit) (S801).

For example, if the merge mode has been applied to the processing block, the decoder may decode a merge index signaled by the encoder. Furthermore, the motion parameter of the current processing block may be derived from the motion parameter of a candidate block indicated by the merge index.

Furthermore, if the AMVP mode has been applied to the processing block, the decoder may decode a horizontal and vertical motion vector difference (MVD), a reference index and an inter-prediction mode signaled by the encoder. Furthermore, the decoder may derive a motion vector predictor from the motion parameter of a candidate block indicated by a motion reference flag, and may derive the motion vector value of a current processing block using the motion vector predictor and the received motion vector difference.

The decoder performs motion compensation on a prediction unit using the decoded motion parameter (or information) (S802).

That is, the encoder/decoder perform motion compensation in which an image of a current unit is predicted from a previously decoded picture using the decoded motion parameter.

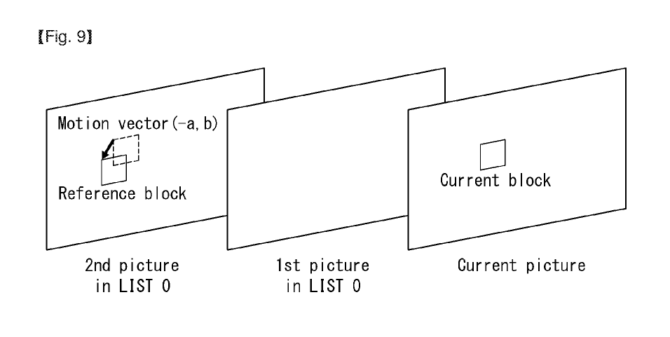

FIG. 9 is an embodiment to which the present invention may be applied and is a diagram illustrating a motion compensation process.

FIG. 9 illustrates a case where a motion parameter for a current block to be encoded in a current picture is uni-direction prediction, a second picture within LIST0, LIST0, and a motion vector (−a, b).

In this case, as in FIG. 9, the current block is predicted using the values (i.e., the sample values of a reference block) of a location (−a, b) spaced apart from the current block in the second picture of LIST0.

In the case of bi-directional prediction, another reference list (e.g., LIST1), a reference index and a motion vector difference are transmitted. The decoder derives two reference blocks and predicts a current block value based on the two reference blocks.

Method for Processing an Image on the Basis of Inter Prediction

Referring to FIG. 1 again, an image encoded and reconstructed by an encoder is stored in the decoded picture buffer (DPB) 170. These images are used in a motion prediction and estimation process for inter picture prediction.

Motion prediction (or motion estimation) refers to a process for finding a block most similar to a currently encoded block in a reference picture, and motion compensation refers to a process for generating pixels the values of which are close to those of the current block by referring to the most similar block.

Motion prediction and motion compensation are performed by using a motion vector which contains position differences between a current block and a reference block, and the motion vector may support ½ or ¼ pixel resolution to support accurate motion compensation.

To perform motion prediction/compensation by using a motion vector expressed by non-integer values, interpolation filtering may be performed, which generates sub-pixels from pixels of integer values. Interpolation filtering may be performed in the inter prediction unit 181 of FIG. 1.

Also, referring to FIG. 2 again, the decoder may perform motion compensation in the inter prediction unit 261, where interpolation filtering may be applied.

In this manner, inter-picture prediction (or inter prediction) is performed through motion estimation and motion compensation in the encoding/decoding process of a video. The inter prediction process references pixel information of the corresponding area in a reference picture indicated by a motion vector, and when the size of the reference picture is large, bandwidth of data is increased.

Accordingly, to reduce data bandwidth, the present invention proposes to scale the bit depth of a reference picture and store the same in a buffer and to re-scale the bit depth of the reference picture stored in the buffer to perform motion prediction/compensation. Also, the present invention proposes to scale the bit depth of a reference picture and store the same in a buffer and to re-scale the bit depth of the reference block during a motion compensation process in which interpolation filtering is performed.

The next-generation broadcasting considers UHD (Ultra-HD) images exceeding the HD resolution as a basic service level, where an UHD image usually has a bit depth of 10 bits or more. In this case, when the present invention is applied to encoding/decoding of a video, an effect may be expected to be obtained that storage space of a reference picture is reduced and bandwidth for compensating a motion occurring frequently during encoding/decoding is reduced.

### Embodiment 1

The present invention proposes a method for scaling the bit depth of a reconstructed image and storing the same in a reference picture buffer (RPB) and re-scaling the bit depth of the reference picture stored in the RPB before performing motion prediction and motion compensation.

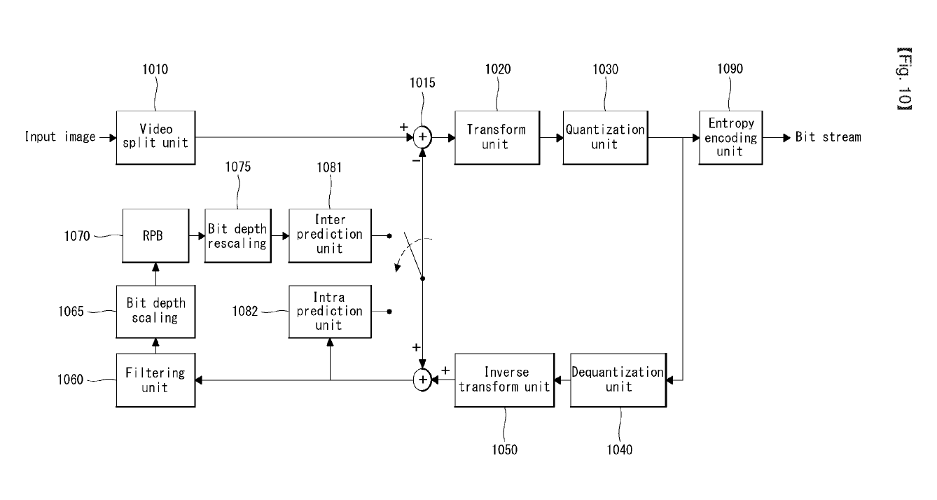

FIG. 10 illustrates a block diagram of an encoder according to one embodiment of the present invention.

Referring to FIG. 10, the encoder includes a video split unit 1010, subtractor 1015, transform unit 1020, quantization unit 1030, inverse quantization unit 1040, inverse transform unit 1050, filtering unit 1060, bit depth scaling unit 1065, reference picture buffer (RPB) 1070, bit depth re-scaling unit 1075, inter prediction unit 1081, intra prediction unit 1082, and entropy encoding unit 1090.

Compared with an encoder example of FIG. 1, the encoder of FIG. 10 may further include the bit depth scaling unit 1065, RPB 1070, and bit depth re-scaling unit 1075.

The example of FIG. 10 illustrates a case in which the encoder does not include a DPB (Decoded Picture Buffer); however, when the encoder outputs a reconstructed image, the reconstructed picture output from the filtering unit 1060 is stored in the DPB, and the reconstructed picture may be output according to an output order.

In what follows, descriptions are given only to the portion showing differences from the descriptions of FIG. 1.

The bit depth scaling unit 1065 receives a reconstructed picture (or reconstructed signal/reconstructed block) filtered by the filtering unit 1060, scales the bit depth of a picture, and transmits an image the bit depth of which has been scaled to the RPB 1070. The bit depth of a picture transmitted to the RPB 1070 may be re-scaled in the bit depth re-scaling unit 1075 and used as a reference picture in the inter prediction unit 1081.

The bit depth scaling unit 1065 may scale the bit depth of a reconstructed picture in various ways, detailed descriptions of which will be given later.

If the method for scaling/re-scaling bit depth is fixed and is applied for both the transmitting end (namely encoder) and the receiving end (namely decoder), the encoder may not transmit additional information (namely information about the method for scaling/re-scaling bit depth) to the decoder. In this case, the bit depth scaling unit 1065 may scale the bit depth of a picture by using a predetermined scaling/re-scaling method.

Also, the encoder may select the method for scaling/re-scaling bit depth appropriately from among various methods available for scaling/re-scaling bit depth by taking into account characteristics of a picture, size of storage space, and the like. In this case, the encoder may determine the method for scaling/re-scaling bit depth at the level of the whole sequences (namely a set of a plurality of pictures), at the picture level, at the slice level, or at the block (for example, prediction block or coding block) level, respectively; and transmit information about the method for scaling/re-scaling bit depth to the decoder.

At this time, the bit depth scaling unit 1065 may scale the bit depth by using the determined scaling/re-scaling method. And the decoder may derive a method for scaling/re-scaling bit depth from the information received from the encoder and scale/re-scale the bit depth of a picture by using the derived scaling/re-scaling method.

Also, the encoder/decoder may apply the same rule or parameters so that the encoder and decoder have the same method for scaling/re-scaling bit depth. In this case, too, the encoder/decoder may determine the method for scaling/re-scaling bit depth at the whole sequence level, picture level, slice level, or block level. The bit depth scaling unit 1065 may scale/re-scale the bit depth of a picture by using the determined scaling/re-scaling method.

The RPB 1070 may store a reconstructed picture the bit depth of which has been scaled to use the reconstructed picture as a reference picture in the inter prediction unit 1081. By scaling the bit depth of a reconstructed picture and storing the same in the RPB 1070, the size of a storage space of the RPB 1070 may be reduced, and bandwidth for data transmission required at the time of referencing for motion prediction/compensation.

When the inter prediction unit 1081 reads a reconstructed picture stored in the RPB 1070, the bit depth of which has been scaled as a reference picture for a block to be currently encoded/decoded, the bit depth re-scaling unit 1075 may re-scale the bit depth of the corresponding reference picture and deliver the re-scaled bit depth to the inter prediction unit 1081.

The bit depth re-scaling unit 1075 may re-scale the bit depth of a reconstructed picture in various ways, detailed descriptions of which will be given later.

As described above, if the method for scaling/re-scaling bit depth is fixed and is applied for both the transmitting end (namely encoder) and the receiving end (namely decoder), the encoder may not transmit additional information (namely information about the method for scaling/re-scaling bit depth) to the decoder. In this case, the bit depth re-scaling unit 1075 may re-scale the bit depth of a picture by using a predetermined scaling/re-scaling method.

Also, as described above, the encoder may select the method for scaling/re-scaling bit depth appropriately from among various methods available for scaling/re-scaling bit depth by taking into account characteristics of a picture, size of storage space, and the like. In this case, the encoder may determine the method for scaling/re-scaling bit depth at the level of the sequence, at the picture level, at the slice level, or at the block level, respectively; and transmit information about the method for scaling/re-scaling bit depth to the decoder. At this time, the bit depth re-scaling unit 1075 may re-scale the bit depth of a picture by using the determined scaling/re-scaling method.

Also, as described above, the encoder/decoder may apply the same rule or parameters so that the encoder and decoder have the same method for scaling/re-scaling bit depth. In this case, too, the encoder/decoder may determine the method for scaling/re-scaling bit depth at the whole sequence level, picture level, slice level, or block level. The bit depth re-scaling unit 1075 may scale/re-scale the bit depth of a picture by using the determined scaling/re-scaling method.

The inter prediction unit 1081 performs temporal prediction and/or spatial prediction to remove temporal redundancy and/or spatial redundancy by referencing a reconstructed picture.

The inter prediction unit 1081 may perform the inter prediction process described above. In particular, the inter prediction unit 1081 according to the present invention may perform motion prediction and motion compensation by using a reference picture the bit depth of which has been re-scaled by the bit depth re-scaling unit 1075.

Also, to support a motion vector in units of factional samples, the inter prediction unit 1081 may perform an interpolation filtering process (refer to FIG. 6) on the reference picture the bit depth of which has been re-scaled by the bit depth re-scaling unit 1075.

Except for the process of storing a reconstructed picture the bit depth of which has been scaled in the RPB and the process of scaling/re-scaling bit depth while a reference picture is read out, the encoder of FIG. 10 may be constructed in the same way as an existing encoder as shown in FIG. 1. In this case, an advantageous effect may be obtained such that existing encoder module may be exploited.

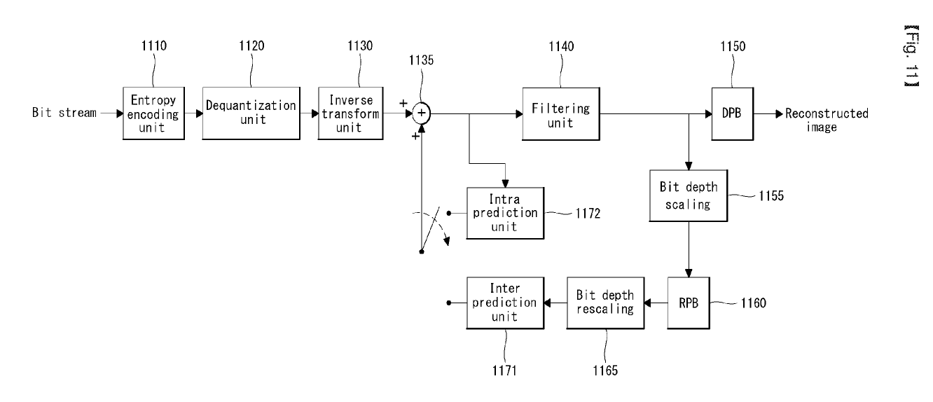

FIG. 11 illustrates a block diagram of a decoder according to one embodiment of the present invention.

Referring to FIG. 11, the decoder may include an entropy decoding unit 1110, inverse quantization unit 1120, inverse transform unit 1130, adder 1135, filtering unit 1140, decoded picture buffer (DPB) 1150, bit depth scaling unit 1155, RPB 1160, bit depth re-scaling unit 1165, inter prediction unit 1171, and intra prediction unit 1172.

Compared with a decoder example of FIG. 2, the decoder of FIG. 11 may further include the bit depth scaling unit 1155, RPB 1160, and bit depth re-scaling unit 1165. In what follows, descriptions are given only to the portion showing differences from the descriptions of FIG. 2.

The bit depth scaling unit 1155 receives a reconstructed picture (or reconstructed signal/reconstructed block) filtered by the filtering unit 1140, scales the bit depth of a picture, and transmits an image the bit depth of which has been scaled to the RPB 1160. The bit depth of a picture transmitted to the RPB 1070, the bit depth of which has been scaled, may be re-scaled in the bit depth re-scaling unit 1165 and used as a reference picture in the inter prediction unit 1171.

The bit depth scaling unit 1155 may scale the bit depth of a reconstructed picture in various ways, detailed descriptions of which will be given later.

As described above, if the method for scaling/re-scaling bit depth is fixed and is applied for both the encoder and the decoder, the bit depth scaling unit 1155 may scale the bit depth of a picture by using a predetermined method for scaling/re-scaling bit depth.

Also, as described above, if the encoder signals information about a method for scaling/re-scaling bit depth to the decoder, the bit depth scaling unit 1155 derives a method for scaling/re-scaling bit depth from the information received from the encoder and scales the bit depth of a picture by using the derived scaling/re-scaling method.

Also, as described above, the decoder may apply the same rule or parameters so that the encoder and decoder have the same method for scaling/re-scaling bit depth. At this time, the bit depth scaling unit 1155 may scale the bit depth of a picture by using the determined scaling/re-scaling method.

The RPB 1160 may store a reconstructed picture the bit depth of which has been scaled to use the same as a reference picture in the inter prediction unit 1171.

When the inter prediction unit 1165 reads a reconstructed picture stored in the RPB 1160, the bit depth of which has been scaled as a reference picture for a block to be currently encoded/decoded, the bit depth re-scaling unit 1165 may re-scale the bit depth of the corresponding reference picture and deliver the reference picture the bit depth of which has been re-scaled to the inter prediction unit 1171.

The bit depth re-scaling unit 1165 may re-scale the bit depth of a reconstructed picture in various ways, detailed descriptions of which will be given later.

As described above, if the method for scaling/re-scaling bit depth is fixed and is applied for both the encoder and the decoder, the bit depth re-scaling unit 1165 may re-scale the bit depth of a picture by using a predetermined scaling/re-scaling method.

Also, as described above, if the encoder signals information about a method for scaling/re-scaling bit depth to the decoder, the bit depth re-scaling unit 1165 may derive a method for scaling/re-scaling bit depth from the information received from the encoder and re-scale the bit depth of a picture by using the derived scaling/re-scaling method.

Also, as described above, the decoder may apply the same rule or parameters so that the encoder and decoder have the same method for scaling/re-scaling bit depth. At this time, the bit depth re-scaling unit 1165 may re-scale the bit depth of a picture by using the determined scaling/re-scaling method.

The inter prediction unit 1171 performs temporal prediction and/or spatial prediction to remove temporal redundancy and/or spatial redundancy by referencing a reconstructed picture.

The inter prediction unit 1171 may perform the inter prediction process described above. In particular, the inter prediction unit 1171 according to the present invention may perform motion compensation by using a reference picture the bit depth of which has been re-scaled by the bit depth re-scaling unit 1165.

Also, to support a motion vector in units of factional samples, the inter prediction unit 1171 may perform an interpolation filtering process (refer to FIG. 6) on the reference picture the bit depth of which has been re-scaled by the bit depth re-scaling unit 1165.

The DPB 1150 may receive a reconstructed picture from the filtering unit 1140 and store the same. The reconstructed picture stored in the DPB 1150 may be output according to an output order.

As described above, since the bit depth of a reconstructed picture is scaled, and the reconstructed picture is stored in the RPB 1160 with the scaled bit depth, the reconstructed picture the bit depth of which has been scaled may be used as a reference picture but may not be used as an output picture.

Therefore, the decoder may need an additional buffer for outputting a reconstructed image in addition to the RPB 1160, which is called a DPB 1150 in the present embodiment. However, the DPB is only one example and may be referred to as a different name which indicates a function of a buffer for outputting a reconstructed image.

A process of scaling the bit depth of a reconstructed picture and storing the same in the RPB (1070 of FIG. 10 and 1160 of FIG. 11) and a process of performing motion compensation by re-scaling the bit depth of a picture selected by the RPB (1070 of FIG. 10 and 1160 of FIG. 11) will be described with reference to accompanying drawings.

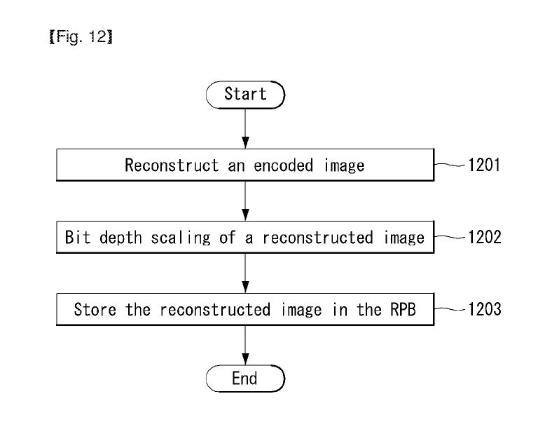

FIG. 12 illustrates a method for processing an image on the basis of inter prediction according to one embodiment of the present invention.

Referring to FIG. 12, the encoder/decoder reconstructs an encoded picture (or image) S1201.

For example, a reconstruction block may be generated by adding a difference block output from the inverse transform unit (1050 of FIG. 10 and 1130 of FIG. 11) to a prediction block output from the inter prediction unit (1081 of FIG. 10 and 1171 of FIG. 11) or intra prediction unit (1082 of FIG. 10 and 1172 of FIG. 11).

A reconstructed picture may be generated from a plurality of reconstruction blocks generated from the aforementioned operation.

The encoder/decoder scales the bit depth of a reconstructed picture (or image) S1202.

In particular, the bit depth scaling unit (1065 of FIG. 10 and 1155 of FIG. 11) may scale the bit depth of a reconstructed picture in various ways, which will be described in detail later.

As described above, if the method for scaling/re-scaling bit depth is fixed and is applied for both the encoder and the decoder, the encoder may not transmit additional information (namely information about a method for scaling/re-scaling bit depth) to the decoder.

Also, as described above, the encoder may select the method for scaling/re-scaling bit depth appropriately from among various methods available for scaling/re-scaling bit depth by taking into account a current situation. In this case, the encoder may determine the method for scaling/re-scaling bit depth appropriately at the level of the sequence, at the picture level, at the slice level, or at the block level, respectively by taking into account the current situation; and transmit information about the method for scaling/re-scaling bit depth to the decoder.

Also, as described above, the encoder/decoder may apply the same rule or parameters so that the encoder and decoder have the same method for scaling/re-scaling bit depth.

If the encoder determines a method for scaling/re-scaling bit depth appropriately considering the current situation or if both the encoder and the decoder determines a method for scaling/re-scaling bit depth in the same manner, a step of determining a method for scaling/re-scaling bit depth may be further included before the S1202 step is performed.

Also, the encoder/decoder may apply filtering to a reconstructed picture and scale the filtered picture. In this case, performing filtering to a reconstructed picture may be further included before the S1202 step is performed.

The encoder/decoder stores a reconstructed picture the bit depth of which has been scaled to the RPB S1203.

For example, the RPB (1070 of FIG. 10 and 1160 of FIG. 11) may store a reconstructed picture the bit depth of which has been scaled.

As described above, when filtering is applied to a reconstructed picture, the encoder/decoder may store the filtered reconstructed picture the bit depth of which has been scaled to the RPB.

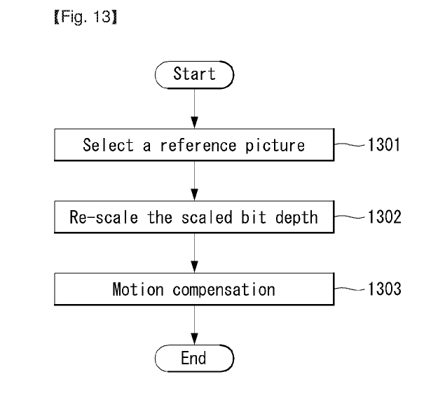

FIG. 13 illustrates a method for processing an image on the basis of inter prediction according to one embodiment of the present invention.

Referring to FIG. 13, the encoder/decoder selects a reference picture for a current block S1301.

As described above, a reference picture buffer in the encoder/decoder may store a reconstructed picture the bit depth of which has been scaled. Therefore, the encoder/decoder may select a reference picture by using a reference index within the reference picture buffer which stores a reference picture the bit depth of which has been scaled.

At this time, the decoder may derive a motion vector and a reference index of a current block and select a reference picture by using the reference index.

As described in detail above, when a merge mode is applied to a current block, the decoder may decode a merge index signaled by the encoder. And the decoder may derive motion parameters of the current block from motion parameters of candidate blocks indicated by merge indexes.

Also, when AMVP mode is applied to a current block, the decoder may decode a signaled horizontal and vertical motion vector difference (MVD), reference index, and inter prediction mode. And the decoder may derive a motion vector estimate from motion parameters of the candidate block indicated by the motion reference flag signaled by the encoder and derive a motion vector value of the current block by using the motion vector estimate and the received motion vector difference value.

The encoder/decoder re-scales the bit depth of a selected reference picture S1302.

In particular, the bit depth re-scaling unit (1075 of FIG. 10 and 1165 of FIG. 11) may re-scale the bit depth of a selected reference picture in various ways, which will be described in detail below.

The encoder/decoder generates a prediction block for a current block S1303.

In other words, the encoder/decoder may perform motion compensation which generates a prediction block for a current block from a previously decoded picture by using motion parameters of a current block. In other words, the encoder/decoder generates a prediction block for the current block on the basis of a sample value of a specific area by using a motion vector within the reference picture (in other words, a reference picture the bit depth of which has been re-scaled in the S1302 step) selected from a reference index.

When interpolation filtering is performed in the motion prediction/compensation process, the encoder/decoder may perform interpolation filtering on a reference picture the bit depth of which has been re-scaled and perform motion prediction or motion compensation within a reference picture to which the interpolation filtering has been applied.

In what follows, a method for scaling bit depth of a reconstructed picture is described.

The following methods may be used to scale the bit depth of an image to be stored in the RPB.

1) Method for removing a specific number of least significant bits (LSBs)

2) Method for scaling bit depth by using a linear relationship

3) Method for scaling bit depth by using a nonlinear relationship

The first method removes as many LSBs as the number of bits scaled in a process of scaling the bit depth of a reference image to the bit depth suitable for being stored in the RPB, which is descried in detail with reference to the appended drawing.

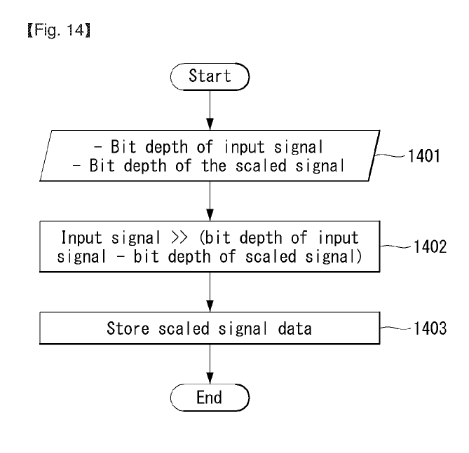

FIG. 14 illustrates a method for scaling bit depth according to one embodiment of the present invention.

The encoder/decoder sets the bit depth of an input signal and the bit depth of a scaled signal S1401.

The encoder/decoder (in particular, the bit depth scaling unit (1065 of FIG. 10 and 1155 of FIG. 11)) may set the bit depth of an input signal by deriving the bit depth from the input signal (namely a reconstructed picture).

Also, the encoder/decoder (in particular, the bit depth scaling unit (1065 of FIG. 10 and 1155 of FIG. 11)) may set the bit depth of a scaled signal to derive the number of bits to be removed.

Also, the bit depth of a scaled signal may be applied after being defined beforehand by the encoder and the decoder. In this case, the encoder and the decoder may set the predetermined bit depth as the bit depth of a scaled signal.

Also, the encoder may determine the bit depth of a scaled signal and transmit the determined bit depth to the decoder. In this case, the bit depth may be transmitted together with information about the method for scaling/re-scaling bit depth described above or separately from the information about the method for scaling/re-scaling bit depth. The decoder may derive the bit depth from the information received from the encoder and set the derived bit depth as the bit depth of the scaled signal.

Also, the encoder/decoder may apply the same rule or parameters so that the encoder and decoder have the same bit depth. The encoder/decoder may set the determined bit depth as the bit depth of a scaled signal.

The encoder/decoder applies the right shift operation as many times as the amount of bit depths determined by subtracting the bit depth of a scaled signal from the bit depth of an input signal S1402.

In other words, the encoder/decoder (in particular, the bit depth scaling unit (1065 of FIG. 10 and 1155 of FIG. 11)) may scale the bit depth of a reconstructed picture by removing as many LSBs of each sample value of the reconstructed picture as obtained by subtracting the bit depth of a scaled signal from the bit depth of an input signal.

For example, when a 12-bit image is scaled down to an 8-bit image, the bit depth may be scaled by applying a method for removing the lower four bits.

For example, if a 12-bit data 1049 (0100 0001 1001_(2)) is an input data, and a method for removing LSBs to scale down the bit depth of the input data to the bit depth of 8 bits, the output data becomes 65 (0100 0001_(2)) which is obtained by shifting lower four bits to the right (namely removing the lower 4 bits 1001).

The encoder/decoder stores the scaled signal data S1403.

In other words, the encoder/decoder (in particular, the bit depth scaling unit (1065 of FIG. 10 and 1155 of FIG. 11)) may store a reconstructed picture the bit field of which has been scaled to the RPB (1070 of FIG. 10 and 1160 of FIG. 11).

The second method scales the bit depth by applying a linear transform to an input reconstructed image, which will be described in detail with reference to appended drawings.

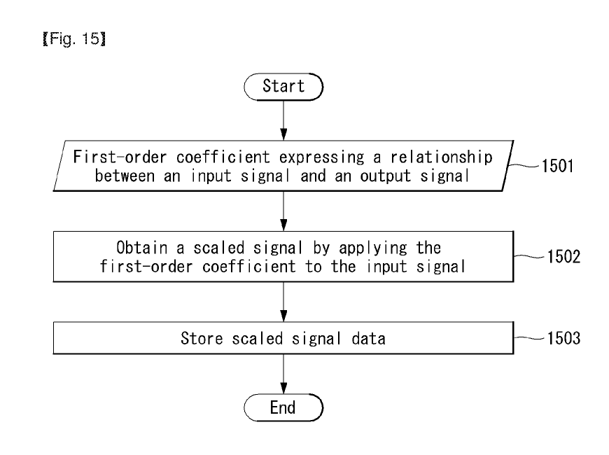

FIG. 15 illustrates a method for scaling bit depth according to one embodiment of the present invention.

Referring to FIG. 15, the encoder/decoder sets a first-order coefficient expressing the relationship between an input signal and an output signal S1501.

Here, the first-order coefficient represents the coefficient value of a linear transform function applied to an input signal.

In other words, the encoder/decoder (in particular, the bit depth scaling unit (1065 of FIG. 10 and 1155 of FIG. 11)) may set the first-order coefficient of a linear transform function applied to an input signal.

At this time, information about a linear transform function may be applied after being defined by the encoder and the decoder. In this case, the encoder and the decoder may set the first-order coefficient of a linear transform function applied to an input signal according to the information about a predetermined linear transform function.

Also, the encoder may determine the first-order coefficient of a linear transform function applied to an input signal and transmit information about the determined linear transform function to the decoder. The decoder derives the first-order coefficient from the information received from the encoder and sets the derived first-order coefficient as the first-order coefficient of the linear transform function applied to an input signal.

Also, the encoder/decoder may apply the same rule or parameters so that the encoder and decoder have the same linear transform function. The encoder/decoder may set the first-order coefficient of the determined linear transform function as the first-order coefficient of a linear transform function applied to an input signal.

The encoder/decoder obtains a scaled signal by applying the first-order coefficient to the input signal S1502.

In other words, the encoder/decoder (in particular, the bit depth scaling unit (1065 of FIG. 10 and 1155 of FIG. 11)) may scale the bit depth of a reconstructed picture by applying a linear transform function having a first-order coefficient set in the S1501 step to the bits represents each sample value of the reconstructed picture.

The encoder/decoder stores scaled signal data S1503.

In other words, the encoder/decoder (in particular, the bit depth scaling unit (1065 of FIG. 10 and 1155 of FIG. 11)) may store a reconstructed picture the bit depth of which has been scaled to the RPB (1080 of FIG. 10 and 1160 of FIG. 11).

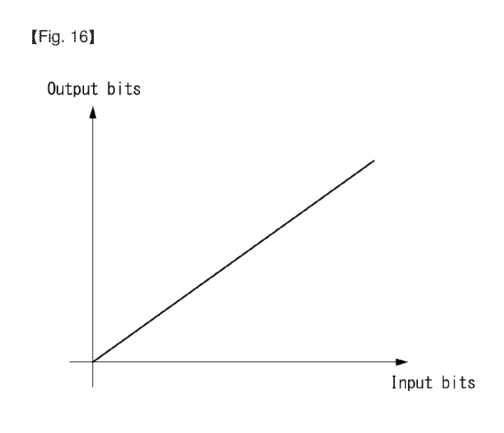

FIG. 16 illustrates a linear transform function according to one embodiment of the present invention.

Referring to FIG. 16, a linear transform function applied to an input signal may have the form of a first-order function. In other words, as shown in FIG. 16, a linear relationship may be formed between input bits and output bits.

For example, a linear transform function may be expressed by Equation 1.

y=α×x [Equation 1]

In the equation above, y represents an output signal (or output bit), and x represents an input signal (or input bits). And α represents a first-order coefficient.

In the case of scaling down 12-bit input data to 8-bit data, the relationship between an input signal (x) and an output signal (y) may be expressed by Equation 2 below.

y=0.0625×x [Equation 2]

For example, when the value of an input signal (x) is 1049, if Equation 2 is applied, the value of an output signal (y) is scaled down to 66 (which is obtained by rounding 65.5625).

In other words, by applying a linear transform function the first-order coefficient (α) of which is 0.0625 to each sample value of a reconstructed picture, the bit depth of the reconstructed picture may be scaled from 12 bit to 8 bit.

The third method scales bit depth by applying nonlinear transformation to a reconstructed image, which will be described in detail with reference to appended drawings.

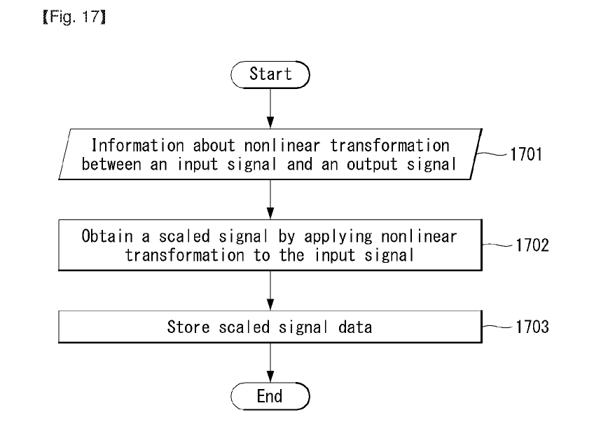

FIG. 17 illustrates a method for scaling bit depth according to one embodiment of the present invention.

Referring to FIG. 17, the encoder/decoder configures nonlinear transformation between an input signal and an output signal S1701.

In other words, the encoder/decoder (in particular, the bit depth scaling unit (1065 of FIG. 10 and 1155 of FIG. 11)) may set a nonlinear transform function to be applied to an input signal.

At this time, information about a nonlinear transform function may be applied after being defined by the encoder and the decoder. In this case, the encoder and the decoder may configure a nonlinear transform function applied to an input signal according to the information about a predetermined nonlinear transform function.

Also, the encoder may determine a nonlinear transform function applied to an input signal and transmit information about the determined nonlinear transform function to the decoder. The decoder may derive a nonlinear transform function from the information received from the encoder and set the derived transform function as a nonlinear transform function applied to an input signal.

Also, the encoder/decoder may apply the same rule or parameters so that the encoder and decoder have the same nonlinear transform function. The encoder/decoder may set the determined nonlinear transform function as the nonlinear transform function applied to an input signal.

The encoder/decoder obtains a scaled signal by applying nonlinear transform to an input signal S1702.

In other words, the encoder/decoder (in particular, the bit depth scaling unit (1065 of FIG. 10 and 1155 of FIG. 11)) may scale the bit depth of a reconstructed picture by applying a nonlinear transform function set in the S1701 step to the bits representing each sample value of the reconstructed picture.

The encoder/decoder stores scaled signal data S1703.

In other words, the encoder/decoder (in particular, the bit depth scaling unit (1065 of FIG. 10 and 1155 of FIG. 11)) may store a reconstructed picture the bit depth of which has been scaled to the RPB (1070 of FIG. 10 and 1160 of FIG. 11).

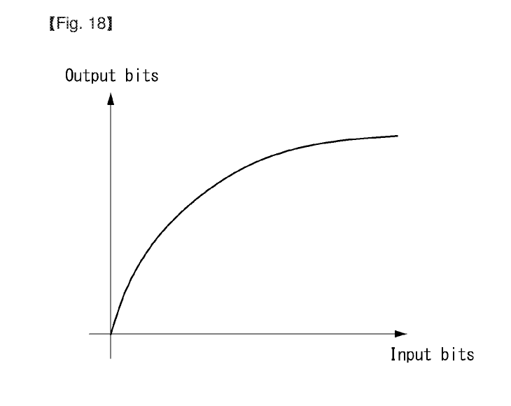

FIG. 18 illustrates a nonlinear transform function according to one embodiment of the present invention.

Referring to FIG. 18, a nonlinear relationship may be formed between input bits and output bits. In other words, output bits may be derived by applying a nonlinear transform function to the input bits.

In the case of scaling down 12-bit input data to 8-bit data, the nonlinear transform function applied to input bits may be expressed by Equation 3 below.

y=255×(x/4095)^{1/2.5} [Equation 3]

For example, if a nonlinear transform function expressed by Equation 3 is applied to an input signal (x) having the value of 1049, the value of a scaled output signal (y) becomes 148 (147.8934068).

In other words, by applying a nonlinear transform function as shown in Equation 3 to each sample value of a reconstructed picture, the bit depth of the reconstructed picture may be scaled from 12 bit to 8 bit.

In describing the present invention, for the convenience of descriptions, a method for constructing and applying a nonlinear transform function has been described with reference to FIG. 18. However, to actually implement the method, the encoder/decoder may construct a nonlinear function and apply the same to an input signal or construct a transform table mapping an input signal to an output signal and apply the transform table to an input signal.

Up to this point, a method for scaling the bit depth of a reconstructed picture has been described. In what follows, a method for re-scaling the bit depth of an image to use an image stored in the RPB for motion compensation will be described.

A process of re-scaling the bit depth of an image stored in the RPB may correspond to an inverse process (or inverse transformation) of scaling the bit depth.

When the bit depth of an image reconstructed by the method for removing LSBs described with reference to FIG. 14 is scaled, the following method may be applied to re-scale the bit depth.

1) The first method fills the removed lower bits with zeroes (namely applies the left shift operation as many times as the number of removed bits) to apply inverse transformation.

In other words, the encoder/decoder may re-scale the bit depth by inserting as many zeroes as the number of removed bits to the LSBs of each sample value of an image stored in the RPB.

Suppose a value of 1049 (0100 0001 1001_(2)) is scaled to 65 (0100 0001_(2)) through the scaling process (namely a method for removing LSBs). In this case, through the re-scaling process, the value of 65 is inversely transformed to 1040 (0100 0001 0000_(2)).

2) The second method applies inverse transformation such that removed lower bits are filled with a middle value of the removed lower bits.

In other words, the encoder/decoder may re-scale the bit depth by inserting the middle value of removed bits to the LSBs of each sample value of an image stored in the RPB.

Suppose a value of 1049 (0100 0001 1001_(2)) is scaled to 65 (0100 0001_(2)) through the scaling process (namely a method for removing LSBs). In this case, since the middle value of the lower four bits is 8, the value of 65 is inversely transformed to 1048 (0100 0001 1000_(2)) through the re-scaling process.

3) The third method may apply inverse transformation by filling removed lower bits with random values. In other words, the encoder/decoder may re-scale the bit depth by inserting a random value to the LSBs of each sample value of an image stored in the RPB. At this time, in order for the encoder and the decoder to use the same random value, 1) the same random value may be predefined for the encoder and the decoder, 2) the encoder may transmit information about a random value to the decoder, or 3) the encoder and the decoder may predefine a function generating a random value, and the encoder may transmit a seed value which initializes a random function to the decoder.

Suppose a value of 1049 (0100 0001 1001_(2)) is scaled to 65 (0100 0001_(2)) through the scaling process (namely a method for removing LSBs). In this case, the encoder/decoder may generate a random value and insert the random value to the lower four bits. In other words, the encoder/decoder may re-scale the bit depth by inserting a random value to the removed lower four bits.

A method for re-scaling bit depth when the bit depth of a picture is scaled by removing LSBs will be described with reference to appended drawings.

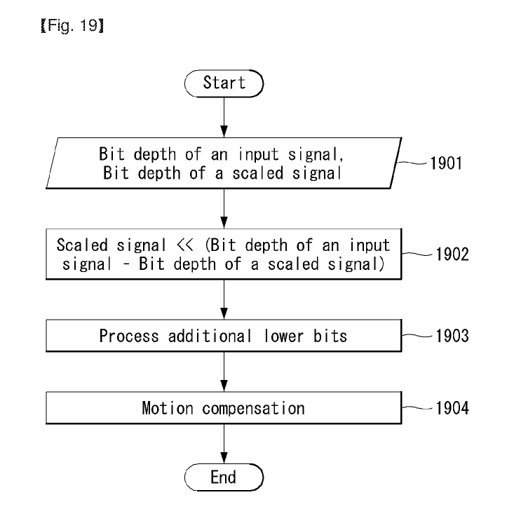

FIG. 19 illustrates a method for re-scaling bit depth according to one embodiment of the present invention.

The encoder/decoder sets the bit depth of an input signal and the bit depth of a scaled signal S1901.

In other words, the encoder/decoder (in particular, the bit depth re-scaling unit (1075 of FIG. 10 and 1165 of FIG. 11)) may set the bit depth of an input signal (namely a reconstructed image) and the bit depth of a scaled signal (namely an image stored in the RPB) to derive the bit depth to be re-scaled.

At this time, the bit depth of an input signal and the bit depth of a scaled signal may be set by the same method as described with reference to FIG. 14, and the bit depth scaling unit (1065 of FIG. 10 and 1155 of FIG. 11) may use the set bit depth.

The encoder/decoder applies the left shift operation to a scaled signal as many times as the amount of bits obtained by subtracting the bit depth of an input signal from the bit depth of the scaled signal S1902.

In other words, as many zero bits as the amount of bits obtained by subtracting the bit depth of a scaled signal from the bit depth of an input signal may be shifted (inserted) to the lower bits (namely LSBs) of the bits representing each sample value of an image stored in the RPB.

The S1902 step may be the same as the first method (namely the method for re-scaling the bit depth by filling removed lower bits with zeros) among those methods for re-scaling the bit depth of an image the LSBs of which have been removed.

The encoder/decoder performs processing additional lower bits.

In other words, the encoder/decoder may insert specific bits to the lower bits added through the left shift operation.

For example, the encoder/decoder may insert a middle value of the removed lower bits into the additional lower bits or a random value to the additional lower bits.

The S1903 step may be the same as the second method (namely the method for re-scaling the bit depth by filling the removed lower bits with a middle value of the removed lower bits) and the third method (namely the method for re-scaling the bit depth by filling the removed lower bits with a random value) among those methods for re-scaling the bit depth of an image the LSBs of which have been removed.

The encoder/decoder generates a prediction block for a current block S1904.

In other words, the encoder/decoder may perform motion compensation which generate a prediction block for a current block from a previously decoded picture by using motion parameters with respect to the current block. In other words, the encoder/decoder may generate a prediction block with respect to a current block on the basis of a sample value of a specific area by using a motion vector within a reference picture (namely the reference picture the bit depth of which has been re-scaled in the previous step of S1904) selected by using a reference index.

When interpolation filtering is performed during the motion compensation process, the encoder/decoder may perform interpolation filtering on a reference picture the bit depth of which has been re-scaled and perform motion prediction or motion compensation within a reference picture to which interpolation filtering has been applied.

As described above, a process of re-scaling the bit depth of an image stored in the RPB may correspond to the inverse process (or inverse transformation) of a process of scaling bit depth.

In other words, when bit depth is scaled by linear or nonlinear transformation, the bit depth may be re-scaled by applying an inverse function of each transformation, which is described with reference to appended drawings.

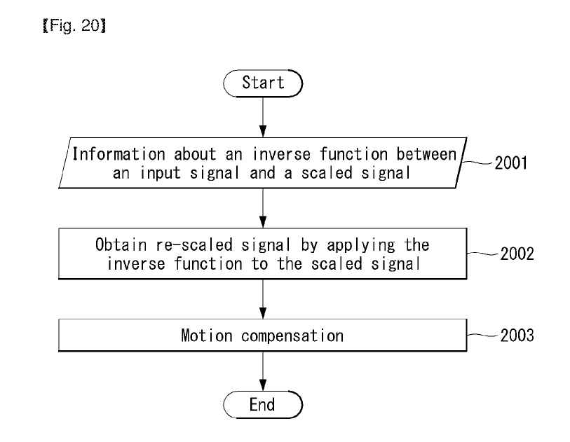

FIG. 20 illustrates a method for re-scaling bit depth according to one embodiment of the present invention.

The encoder/decoder configures an inverse function of an input signal and a scaled signal S2001.

In other words, the encoder/decoder (in particular, the bit depth re-scaling unit (1075 of FIG. 10 and 1165 of FIG. 11)) may derive a linear transform function or a nonlinear transform function applied to an input signal (namely a reconstructed image) and set the inverse function of the linear transform function or the nonlinear transform function that may be applied to a scaled signal (namely an image stored in the RPB) for re-scaling the bit depth.

At this time, the inverse function of a linear transform function or a nonlinear transform function applied to a scaled signal may be set in the same way as the method described with reference to FIGS. 15 and 17 or may be derived from a linear transform function or a nonlinear transform function configured by the bit depth scaling unit (1065 of FIG. 10 and 1155 of FIG. 11).

The encoder/decoder obtains a signal the bit depth of which has been re-scaled by applying an inverse function to a scaled signal S2002.

In other words, the encoder/decoder (in particular, the bit depth re-scaling unit (1075 of FIG. 10 and 1165 of FIG. 11) may re-scale the bit depth by applying the inverse function configured in the S2001 step to each sample value of an image stored in the RPB.

The inverse function of Equation 2 which is a linear transform function may be expressed by Equation 4 below.

y=16×x [Equation 4]

Here, x represents a signal the bit depth of which has been scaled (namely an image stored in the RPB), and y represents a signal the bit depth of which has been re-scaled (namely an image the bit depth of which has been re-scaled).

In the case of scaling/re-scaling input data of 12-bit to 8-bit data, a value of 1049 is scaled to 66 by applying linear transformation of Equation 2 during the scaling process, and a value of 1056 is obtained by applying Equation 4 which is an inverse function of the linear transformation (namely Equation 2) during the re-scaling process.

The inverse function of Equation 3 which expresses nonlinear transformation may be expressed by Equation 5.

y=4095×(x/255)^{2.5} [Equation 5]

Here, x represents a signal the bit depth of which has been scaled (namely an image stored in the RPB), and y represents an image the bit depth of which has been re-scaled.

In the case of scaling/re-scaling input data of 12-bit to 8-bit data, a value of 1049 is scaled to 148 by applying nonlinear transformation of Equation 3 during the scaling process, and a value of 1051 (1050.891171) is obtained by applying Equation 5 which is an inverse function of the nonlinear transformation (namely Equation 3) during the re-scaling process.

The encoder/decoder generates a prediction block for the current block S2003.

In other words, the encoder/decoder may perform motion compensation which generates a prediction block for a current block from a previously decoded picture by using motion parameters with respect to the current block. In other words, the encoder/decoder may generate a prediction block with respect to a current block on the basis of a sample value of a specific area by using a motion vector within a reference picture (namely the reference picture the bit depth of which has been re-scaled in the previous step of S2003) selected by using a reference index.

When interpolation filtering is performed during the motion compensation process, the encoder/decoder may perform interpolation filtering on a reference picture the bit depth of which has been re-scaled and perform motion prediction or motion compensation within a reference picture to which interpolation filtering has been applied.

### Embodiment 2

The present embodiment proposes a method for scaling the bit depth of a reconstructed picture, storing the reconstructed picture the bit depth of which has been scaled in the RPB, and re-scaling the bit depth of the reconstructed picture stored in the RPB during an interpolation filtering process to reduce bandwidth generated while an encoder/decoder of an image performs motion prediction/compensation by using a reference picture.

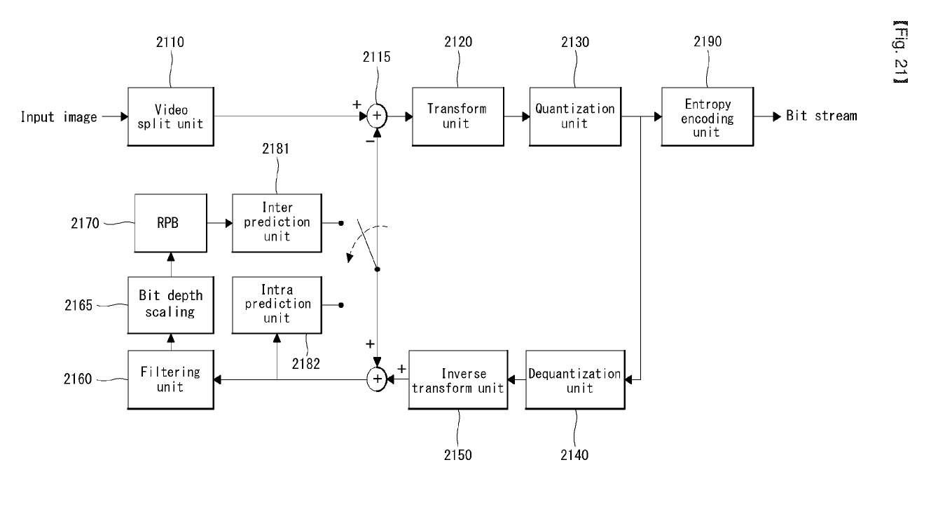

FIG. 21 illustrates a block diagram of an encoder according to one embodiment of the present invention.

Referring to FIG. 21, the encoder includes a video split unit 2110, subtractor 2115, transform unit 2120, quantization unit 2130, inverse quantization unit 2140, inverse transform unit 2150, filtering unit 2160, bit depth scaling unit 2165, reference picture buffer (RPB) 2170, inter prediction unit 2181, intra prediction unit 2182, and entropy encoding unit 2190.

Compared with an encoder example of FIG. 1, the encoder of FIG. 21 may further include the bit depth scaling unit 2165, and the RPB 1070.

The example of FIG. 21 illustrates a case in which the encoder does not include a DPB (Decoded Picture Buffer); however, when the encoder outputs a reconstructed image, the reconstructed picture output from the filtering unit 1060 is stored in the DPB, and the reconstructed picture may be output according to an output order.

In what follows, descriptions are given only to the portion showing differences from the descriptions of FIG. 1.

The bit depth scaling unit 2165 receives a reconstructed picture (or reconstructed signal/reconstructed block) filtered by the filtering unit 2160, scales the bit depth of a picture, and transmits an image the bit depth of which has been scaled to the RPB 2170. The picture transmitted to the RPB 2170, the bit depth of which has been scaled may be used as a reference picture in the inter prediction unit 2181.

The bit depth scaling unit 2165 may scale the bit depth of a reconstructed picture by using the methods described with reference to FIG. 12 and FIGS. 14 to 18.

In other words, a method for scaling bit depth before a reconstructed image is stored in the RPB may be applied in the same way as in the embodiment 1. The encoder/decoder may delete the data of specific bits (namely remove a specific number of LSBs) or scale the bit depth by applying linear transformation or nonlinear transformation.

If the method for scaling/re-scaling bit depth is fixed and is applied for both the transmitting end (namely encoder) and the receiving end (namely decoder), the encoder may not transmit additional information (namely information about the method for scaling/re-scaling bit depth) to the decoder. In this case, the bit depth scaling unit 2165 may scale the bit depth of a picture by using a predetermined scaling/re-scaling method.

Also, the encoder may select the method for scaling/re-scaling bit depth appropriately from among various methods available for scaling/re-scaling bit depth by taking into account characteristics of a picture, size of storage space, and the like. In this case, the encoder may determine the method for scaling/re-scaling bit depth at the level of the whole sequences (namely a set of a plurality of pictures), at the picture level, at the slice level, or at the block (for example, prediction block or coding block) level, respectively; and transmit information about the method for scaling/re-scaling bit depth to the decoder.

At this time, the bit depth scaling unit 2165 may scale the bit depth by using the determined scaling/re-scaling method. And the decoder may derive a method for scaling/re-scaling bit depth from the information received from the encoder and scale/re-scale the bit depth of a picture by using the derived scaling/re-scaling method.

Also, the encoder/decoder may apply the same rule or parameters so that the encoder and decoder have the same method for scaling/re-scaling bit depth. In this case, too, the encoder/decoder may determine the method for scaling/re-scaling bit depth at the whole sequence level, picture level, slice level, or block level. The encoder/decoder may scale/re-scale the bit depth of a picture by using the determined scaling/re-scaling method.

The RPB 2170 may store a reconstructed picture the bit depth of which has been scaled to use the same as a reference picture in the inter prediction unit 1081. By scaling the bit depth of a reconstructed picture and storing the same in the RPB 2170, the size of a storage space of the RPB 2170 may be reduced, and bandwidth for data transmission required at the time of referencing for motion prediction/compensation.

The inter prediction unit 2181 may perform the inter prediction process described above. In other words, the inter prediction unit 2181 performs temporal prediction and/or spatial prediction to remove temporal redundancy and/or spatial redundancy by referencing a reconstructed picture.

In particular, the inter prediction unit 2181 according to the present invention may perform motion prediction and motion compensation by using a reference picture stored in the RPB 2170, the bit depth of which has been scaled. Also, the inter prediction unit 2181 according to the present invention may re-scale the bit depth scaled during the motion prediction /compensation process.

Also, to support a motion vector in units of factional samples, the inter prediction unit 2181 may perform an interpolation filtering process (refer to FIG. 6) on the reference picture the bit field of which has been scaled.

In other words, while a reference picture stored in the RPB 2170, the bit depth of which has been scaled, is used for motion prediction, the inter prediction unit 2181 may perform interpolation filtering when a motion vector of sub-pixel accuracy is applied. At this time, the inter prediction unit 2181 may re-scale the bit field of a reference block during the interpolation filtering process.

The inter prediction unit 2181 may re-scale the bit depth of a reference block in various ways. A process for re-scaling bit depth during the interpolation filtering process will be described later.

If the method for scaling/re-scaling bit depth is fixed and is applied for both the transmitting end (namely encoder) and the receiving end (namely decoder), the encoder may not transmit additional information (namely information about the method for scaling/re-scaling bit depth) to the decoder. In this case, the inter prediction unit 2181 may re-scale the bit depth of a picture by using a predetermined scaling/re-scaling method.

Also, as described above, the encoder may select the method for scaling/re-scaling bit depth appropriately from among various methods available for scaling/re-scaling bit depth by taking into account characteristics of a picture, size of storage space, and the like. In this case, the encoder may determine the method for scaling/re-scaling bit depth at the sequence level, at the picture level, at the slice level, or at the block level, respectively; and transmit information about the method for scaling/re-scaling bit depth to the decoder. At this time, the inter prediction unit 2181 may re-scale the bit depth of a reference block by using the determined scaling/re-scaling method.

Also, as described above, the encoder/decoder may apply the same rule or parameters so that the encoder and decoder have the same method for scaling/re-scaling bit depth. In this case, too, the encoder/decoder may determine the method for scaling/re-scaling bit depth at the whole sequence level, picture level, slice level, or block level. At this time, the inter prediction unit 2181 may re-scale the bit depth of a reference block by using the determined scaling/re-scaling method.

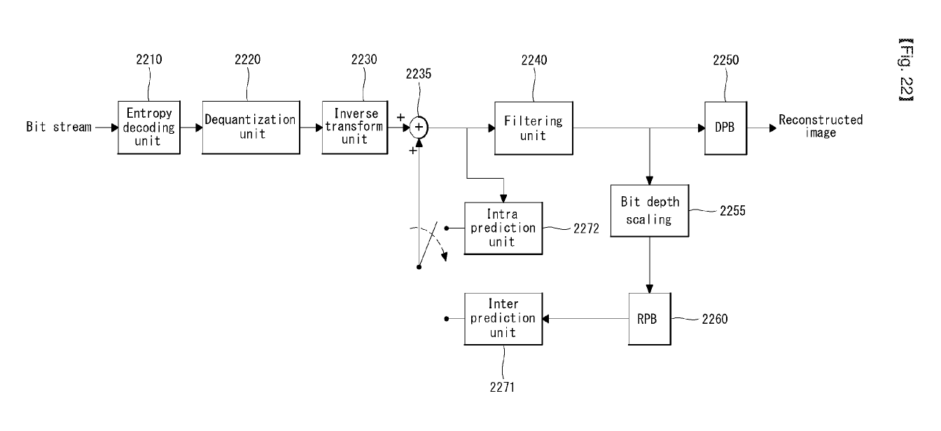

FIG. 22 illustrates a block diagram of a decoder according to one embodiment of the present invention.

Referring to FIG. 22, the decoder may include an entropy decoding unit 2210, inverse quantization unit 2220, inverse transform unit 2230, adder 2235, filtering unit 2240, decoded picture buffer (DPB) 2250, bit depth scaling unit 2255, RPB 2260, inter prediction unit 2271, and intra prediction unit 2272.

Compared with a decoder example of FIG. 2, the decoder of FIG. 22 may further include the bit depth scaling unit 2255 and RPB 2260. In what follows, descriptions are given only to the portion showing differences from the descriptions of FIG. 2.

The bit depth scaling unit 2255 receives a reconstructed picture (or reconstructed signal/reconstructed block) filtered by the filtering unit 2240, scales the bit depth of a picture, and transmits an image the bit depth of which has been scaled to the RPB 2260. The bit depth of a picture transmitted to the RPB 2260, the bit depth of which has been scaled is re-scaled in the inter prediction unit 2271 and is used as a reference picture.

The bit depth scaling unit 2165 may scale the bit depth of a reconstructed picture by using the methods described with reference to FIG. 12 and FIGS. 14 to 18.

In other words, a method for scaling bit depth before a reconstructed image is stored in the RPB may be applied in the same way as in the embodiment 1. The bit depth may be scaled by deleting the data of specific bits (namely by removing a specific number of LSBs) or by scaling the bit depth by applying linear transformation or nonlinear transformation.

If the method for scaling/re-scaling bit depth is fixed and is applied for both the encoder and the decoder, the bit depth scaling unit 2255 may scale the bit depth of a picture by using the predetermined method for scaling/re-scaling bit depth.

Also, as described above, when the encoder signals information about a method for scaling/re-scaling bit depth to the decoder, the bit depth scaling unit 2255 may derive a method for scaling/re-scaling bit depth on the basis of the information received from the encoder and scale the bit depth of a picture by using the derived scaling/re-scaling method.

Also, as described above, by using the same rule or parameters, the decoder may determine the method for scaling/re-scaling bit depth in the same manner as the encoder. At this time, the bit depth scaling unit 2255 may scale the bit depth of a picture by using the determined scaling/re-scaling method.

The RPB 2260 may store the reconstructed picture the bit depth of which has been scaled so that the inter prediction unit 2271 may use the reconstructed picture as a reference picture.

The inter prediction unit 2271 may perform the inter prediction process described above. In other words, the inter prediction unit 2271 performs temporal prediction and/or spatial prediction to remove temporal redundancy and/or spatial redundancy by referencing a reconstructed picture.

In particular, the inter prediction unit 2271 according to the present invention may perform motion prediction and motion compensation by using a reference picture stored in the RPB 2260, the bit depth of which has been scaled. Also, the inter prediction unit 2271 according to the present invention may re-scale the bit depth scaled during the motion prediction/compensation process.

Also, to support a motion vector in units of factional samples, the inter prediction unit 2271 may perform an interpolation filtering process (refer to FIG. 6) on the reference picture the bit field of which has been scaled.

In other words, while a reference picture stored in the RPB 2260, the bit depth of which has been scaled, is used for motion prediction, the inter prediction unit 2271 may perform interpolation filtering when a sub-pixel level motion vector is applied. At this time, the inter prediction unit 2271 may re-scale the bit field of a reference block during the interpolation filtering process.

The inter prediction unit 2271 may re-scale the bit depth of a reference block in various ways. A process for re-scaling bit depth during the interpolation filtering process will be described later.

As described above, if the method for scaling/re-scaling bit depth is fixed and is applied for both the encoder and the decoder, the inter prediction unit 2271 may re-scale the bit depth of a reference block by using the predetermined method for scaling/re-scaling bit depth.

Also, as described above, if the encoder signals information about a method for scaling/re-scaling bit depth to the decoder, the inter prediction unit 2271 may derive a method for scaling/re-scaling bit depth from the information received from the encoder and re-scale the bit depth of a picture by using the derived scaling/re-scaling method.

Also, as described above, the decoder may apply the same rule or parameters so that the encoder and decoder have the same method for scaling/re-scaling bit depth. At this time, the inter prediction unit 2271 may re-scale the bit depth of a picture by using the determined scaling/re-scaling method.

The DPB 2250 may receive a reconstructed picture from the filtering unit 2240 and store the same. The reconstructed picture stored in the DPB 2250 may be output according to an output order.

As described above, since the bit depth of a reconstructed picture is scaled and stored in the RPB 2260 as such, a reconstructed picture the bit depth of which has been scaled may be used as a reference picture but may not be used as an output picture.

Therefore, the decoder may need an additional buffer for outputting a reconstructed image in addition to the RPB 2260, which is called a DPB 2250 in the present embodiment. However, the DPB is only one example and may be referred to as a different name which indicates a function of a buffer for outputting a reconstructed image.

In the interpolation filtering process, re-scaling of bit depth may be performed by using the following methods:

1) Method in which re-scaling of bit depth is performed before interpolation filtering,

2) Method in which re-scaling of bit depth is performed after interpolation filtering, and

3) Method in which re-scaling of bit depth is performed during interpolation filtering.

The first method re-scales the bit depth of a reference block before interpolation filtering is performed.

As described above, in the case of Embodiment 1, too, interpolation filtering may be performed on a reference picture the bit depth of which has been re-scaled.

However, although the present method is the same as the Embodiment 1 in that bit depth is re-scaled before interpolation filtering is performed, the present method is different from the Embodiment 1 in that re-scaling of bit depth is performed in units of blocks which perform motion prediction/compensation.

In other words, rather than the bit depth re-scaling unit (1075 of FIG. 10 and 1165 of FIG. 11), the inter prediction unit (2181 of FIGS. 21 and 2271 of FIG. 22) may re-scale the bit depth of a reference block specified by motion information of a current block within a reference picture stored in the RPB, the bit depth of which has been scaled, in units of current blocks performing inter prediction; and perform motion prediction/compensation by using the reference block the bit depth of which has been re-scaled.

Here, for the reference block specified by motion information within a reconstructed picture the bit depth of which has been scaled, the bit depth may be re-scaled by using the method described in the Embodiment 1 (refer to FIGS. 19 and 20).

For example, if a reconstructed image the bit depth of which is 8 bit is scaled to the image of a bit depth of 6 bits and stored in the RPB, the first method performs interpolation filtering after the bit depth of a reference block is re-scaled to the 8 bit, the bit depth of the original image.

At this time, in the case of the HEVC, the reference block the bit depth has been re-scaled to 8 bit is up-scaled to have the bit depth of 14 bits during the interpolation filtering process, after which integer operations are performed; in the final step (namely after motion prediction/compensation), the reference block is re-scaled to the bit depth of 8 bits.

Therefore, since bit depth is re-scaled before interpolation filtering is performed, the first method is advantageous in that the existing interpolation filtering process may be applied directly.

The second method re-scales the bit depth of a motion predicted/compensated image (namely a reference block derived by motion prediction/compensation) to the original magnitude (namely to the bit depth of the original image) after interpolation filtering.

In other words, the interpolation filtering may perform in accordance with the bit depth of an image stored in the RPB, and the bit depth of a reference block (or prediction block) derived through motion prediction/compensation may be re-scaled to the bit depth of the original image. At this time, the bit depth of the reference block may be re-scaled according to the method described in the Embodiment 1 (refer to FIGS. 19 and 20).

For example, when a re-scaled image the bit depth of which is 8 bit is scaled to have the bit depth of 6 bits and is stored in the RPB, the second method may apply interpolation filtering to a reference block the bit depth of which has been scaled to 6 bits.

At this time, in the case of the HEVC, a reference block the bit depth of which has been scaled to 6 bits may be up-scaled to have the bit depth of 14 bits (or 12 bits) during the interpolation filtering process, after which integer operations may be performed. After motion prediction/compensation is performed, the bit depth of the reference block may be re-scaled to 6 bits which is the bit depth of the reference block before the interpolation filtering is performed, after which, by applying the method described in the Embodiment 1, the bit depth may be re-scaled to 8 bits which is the bit depth of the original image.

The third method re-scales bit depth during interpolation filtering.

The interpolation filtering performs calculations at a higher bit depth than that of an input image to improve accuracy of integer operations and to perform high-speed operations. In the case of the HEVC, when interpolation filtering is applied to an input image having the bit depth of 8 bits, the input image is up-scaled to have the bit depth of 14 bits, after which integer operations are performed. And in the final step, the up-scaled image is re-scaled to have the bit depth of 8 bits.

Since the present method stores an original image in the RPB to have a scaled bit depth, the encoder/decoder may perform integer operations at a higher bit depth than that of the original image during the interpolation filtering process and re-scale the bit depth to that of the original image at the final step.

In the example of the HEVC, when a reconstructed image having the bit depth of 8 bits is scaled to have the bit depth of 6 bits and is stored in the RPB, interpolation filtering may be applied to the image the bit depth of which has been scaled to 6 bits, and integer operations may be performed at the bit depth of 14 bits. And after motion prediction/compensation is performed, the bit depth of a reference block may be re-scaled to 8 bits which is the bit depth of the original image.

During the process, before adjusting the final computation result to the bit depth of the original image, an inverse operation of the process for scaling the bit depth may be applied. In other words, before re-scaling the bit depth to that of the original image in the final step, the method (refer to FIGS. 19 and 20) described in the Embodiment 1 may be applied.

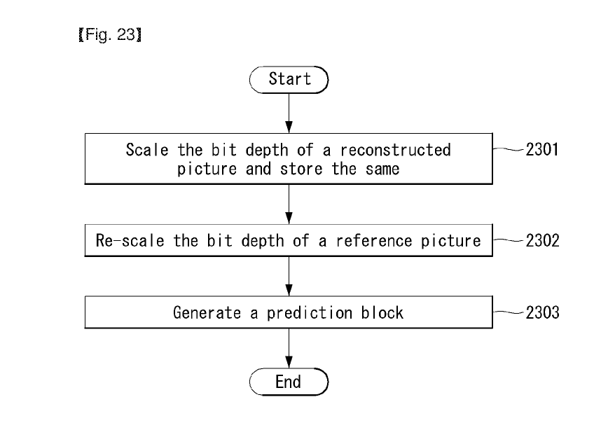

FIG. 23 illustrates a method for processing an image on the basis of inter prediction according to one embodiment of the present invention.

Referring to FIG. 23, the encoder/decoder scales the bit depth of a reconstructed picture and stores the same in the reference picture buffer S2301.

As described above, the reference picture buffer within the encoder/decoder may store a reconstructed picture the bit depth of which has been scaled.

Also, as described above, the encoder/decoder may scale the bit depth of a reconstructed picture in various ways.

More specifically, the encoder/decoder may scale the bit depth of a reconstructed picture according to the method described with reference to FIG. 14 to FIG. 18. In other words, the encoder/decoder may delete the data of specific bits (namely a specific number of LSBs) or scale the bit depth by applying linear transformation or nonlinear transformation.

As described above, if the method for scaling/re-scaling bit depth is fixed and is applied for both the encoder and the decoder, the encoder may not transmit additional information (namely information about the method for scaling/re-scaling bit depth) to the decoder.

Also, the encoder may select the method for scaling/re-scaling bit depth appropriately from among various methods available for scaling/re-scaling bit depth by taking into account characteristics of a picture, size of storage space, and the like. In this case, the encoder may determine the method for scaling/re-scaling bit depth at the level of the whole sequences (namely a set of a plurality of pictures), at the picture level, at the slice level, or at the block (for example, prediction block or coding block) level, respectively; and transmit information about the method for scaling/re-scaling bit depth to the decoder.

Also, the encoder/decoder may apply the same rule or parameters so that the encoder and decoder have the same method for scaling/re-scaling bit depth. In this case, too, the encoder/decoder may determine the method for scaling/re-scaling bit depth at the whole sequence level, picture level, slice level, or block level.

The encoder/decoder re-scales the bit depth of a reference picture S2302.

As described above, the encoder/decoder may re-scale the bit depth of an image stored in the reference picture buffer to perform motion prediction/compensation.

The encoder/decoder may re-scale the bit depth of an image, the bit depth of which has been scaled, in various ways.

More specifically, the encoder/decoder may re-scale the bit depth of an image by using the method described with reference to FIGS. 19 and 20. As described above, a process of re-scaling the bit depth of an image stored in the reference picture buffer may correspond to the inverse process (or inverse transformation) of a process of scaling bit depth.

In other words, when the bit depth of a reconstructed image is scaled according to a method for removing LSBs, the encoder/decoder may re-scale the bit depth by inserting zeros to the removed lower bits, inserting the middle value of the removed lower bits, or inserting a random value.

Also, when the bit depth of a reconstructed picture is scaled by applying a linear or a nonlinear transform function, the encoder/decoder may re-scale the bit depth by applying an inverse transform function of the transform function.

As described above, if the method for scaling/re-scaling bit depth is fixed and is applied for both the encoder and the decoder, the encoder may not transmit additional information (namely information about a method for scaling/re-scaling bit depth) to the decoder.

Also, as described above, the encoder may select the method for scaling/re-scaling bit depth appropriately from among various methods available for scaling/re-scaling bit depth by taking into account characteristics of a picture, size of storage space, and the like. In this case, the encoder may determine the method for scaling/re-scaling bit depth at the sequence level, at the picture level, at the slice level, or at the block level, respectively; and transmit information about the method for scaling/re-scaling bit depth to the decoder.

Also, as described above, the encoder/decoder may apply the same rule or parameters so that the encoder and decoder have the same method for scaling/re-scaling bit depth. In this case, too, the encoder/decoder may determine the method for scaling/re-scaling bit depth at the whole sequence level, picture level, slice level, or block level.

Also, as described above, to support a motion vector in units of factional samples, the encoder/decoder may perform the interpolation filtering process (refer to FIG. 6) on the reference picture the bit field of which has been scaled. At this time, the encoder/decoder may re-scale the bit depth of a reference picture during the interpolation filtering process.

The encoder/decoder generates a prediction block for a current block S2303.

In other words, by using motion parameters of the current block, the encoder/decoder may perform motion compensation which predicts the image of the current block from a previously decoded picture. In other words, the encoder/decoder may generate a prediction block for the current block on the basis of sample values of a specific area by using the motion vector within a reference picture (namely a reference picture the bit depth of which has been extended through the S2302 step) selected by using a reference index.

Meanwhile, although the examples of FIGS. 10, 11, 21, and 22 according to the Embodiment 1 and 2 illustrate the case in which the bit depth scaling unit performing scaling of bit depth is included in the encoder and/or the decoder as a separate constituting element, the present invention is not limited to the specific examples. In other words, the operation performed by the bit depth scaling unit described above may be performed in the same manner in the RPB, where, in this case, the bit depth scaling unit may not be included in the encoder and/or the decoder as a separate constituting element.

Also, although the examples of FIGS. 10 and 11 according to the Embodiment 1 illustrates the case in which the bit depth re-scaling unit performing re-scaling of bit depth is included in the encoder and/or the decoder as a separate constituting element, the present invention is not limited to the specific examples. In other words, the operation performed by the bit depth re-scaling unit described above may be performed in the same manner in the inter prediction unit, where, in this case, the bit depth re-scaling unit may not be included in the encoder and/or the decoder as a separate constituting element.

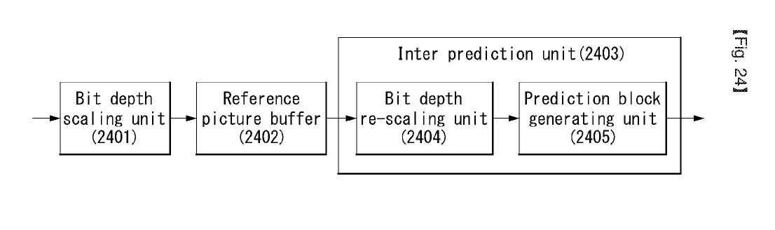

FIG. 24 illustrates an encoding/decoding apparatus according to one embodiment of the present invention.

The specific structure of the encoder/decoder of FIG. 24 is only an example; part of the specific structure of the encoder/decoder of FIG. 24 may be implemented by being included in another specific structure, part of the specific structure may be implemented as a functionally separated element, or another structure not shown in FIG. 24 may be implemented together by being added to the specific structure of the example.

Referring to FIG. 24, the encoder/decoder implements functions, processes and/or methods proposed in FIGS. 5 to 23. More specifically, the encoder/decoder may include a bit depth scaling unit 2401, reference picture buffer (RPB) 2402, and inter prediction unit 2403. Also, the inter prediction unit 2403 may include a bit depth re-scaling unit 2404 and a prediction block generating unit 2405.

Although FIG. 24 illustrates a structure in which the bit depth re-scaling unit 2404 is included in the inter prediction unit 2403, the bit depth re-scaling unit 2404 may be implemented as an internal element of the inter prediction unit 2403 or implemented by being separated from the inter prediction unit 2403.

Also, as described above, the bit depth scaling unit 2401 may be implemented as a separate element or may be implemented as an internal element of the reference picture buffer 2402.

The bit depth scaling unit 2401 may scale the bit depth of a reconstructed picture.

More specifically, the bit depth scaling unit 2401 may scale the bit depth of a reconstructed picture according to the method described with reference to FIG. 14 to FIG. 18. In other words, the bit depth scaling unit 2401 may delete the data of specific bits (namely a specific number of LSBs) or scale the bit depth by applying linear transformation or nonlinear transformation.

The reference picture buffer 2402 may store a reconstructed picture the bit depth of which has been scaled to use the reconstructed picture as a reference picture in the inter prediction unit 2403.

The bit depth re-scaling unit 2404 may re-scale the bit depth of a reference picture stored in the reference picture buffer 2402.

More specifically, the bit depth re-scaling unit 2404 may re-scale the bit depth of an image according to the method described with reference to FIGS. 19 and 20. As described above, a process of re-scaling the bit depth of an image stored in the reference picture buffer 2402 may correspond to the inverse process (or inverse transformation) of a process of scaling bit depth.

In other words, when the bit depth of a reconstructed image is scaled according to a method for removing LSBs, the bit depth re-scaling unit 2404 may re-scale the bit depth by inserting zeros to the removed lower bits, inserting the middle value of the removed lower bits, or inserting a random value.

Also, when the bit depth of a reconstructed picture is scaled by applying a linear or a nonlinear transform function, the bit depth re-scaling unit 2404 may re-scale the bit depth by applying an inverse transform function of the transform function.

Also, as described above, to support a motion vector in units of factional samples, the inter prediction unit 2403 may perform the interpolation filtering process (refer to FIG. 6) on the reference picture the bit field of which has been scaled. At this time, the bit depth re-scaling unit 2404 may re-scale the bit depth of a reference picture during the interpolation filtering process.

The prediction block generating unit 2405 may generate a prediction block for a current block.

In other words, the prediction block generating unit 2405 may generate a prediction block for the current block on the basis of sample values of a specific area by using the motion vector within a reference picture (namely a reference picture the bit depth of which has been re-scaled by the bit depth re-scaling unit 2404) selected by using a reference index.

The embodiments described above are combinations of constituting elements and features of the present invention in a predetermined form. Each individual element or feature has to be considered as optional except where otherwise explicitly indicated. Each individual element or feature may be implemented solely without being combined with other elements or features. Also, it is also possible to construct the embodiments of the present invention by combining a portion of the elements and/or features. A portion of a structure or feature of an embodiment may be included in another embodiment or may be replaced with the corresponding structure of feature of another embodiment. It should be clearly understood that the claims which are not explicitly cited within the technical scope of the present invention may be combined to form an embodiment or may be included in a new claim by an amendment after application.

The embodiments of the present invention may be implemented by various means such as hardware, firmware, software, or a combination thereof. In the case of hardware implementation, one embodiment of the present invention may be implemented by using one or more of ASICs (Application Specific Integrated Circuits), DPSs (Digital Signal Processors), DSPDs (Digital Signal Processing Devices), PLDs (Programmable Logic Devices), FPGAs (Field Programmable Gate Arrays), processors, controllers, micro-controllers, and micro-processors.

In the case of implementation by firmware or software, one embodiment of the present invention may be implemented in the form of modules, procedures, functions, and the like which perform the functions or operations described above. Software codes may be stored in the memory and activated by the processor. The memory may be located inside or outside of the processor and may exchange data with the processor by using various well-known means.

It is apparent for those skilled in the art that the present invention may be embodied in other specific forms without departing from the essential characteristics of the present invention. Therefore, the detailed descriptions above should be regarded as being illustrative rather than restrictive in every aspect. The technical scope of the present invention should be determined by a reasonable interpretation of the appended claims, and all of the modifications that fall within an equivalent scope of the present invention belong to the technical scope of the present invention.

### INDUSTRIAL APPLICABILITY

The preferred embodiments of the present invention have been disclosed for the purpose of illustration, and it should be understood by those skilled in the art that various modifications, changes, substitutions, or additions may be made to the present invention without departing from the technical principles and scope specified by the appended claims below.

1. A method for processing an image based on inter prediction, comprising:
scaling a bit depth of a reconstructed picture and storing the reconstructed picture in a reference picture buffer;
re-scaling the bit depth of the reference picture of a current block among the reconstructed pictures stored in the reference picture buffer; and
generating a prediction block for the current block based on the reference picture in which the bit depth is re-scaled.

2. The method of claim 1, wherein the bit depth of the reconstructed picture is scaled by removing a specific number of least significant bits (LSB) from each sample value of the reconstructed picture.

3. The method of claim 2, wherein the bit depth of the reference picture is re-scaled by inserting as many zeros as the number of removed bits to the LSBs of each sample value of the reference picture.

4. The method of claim 2, wherein the bit depth of the reference picture is re-scaled by inserting the middle value of removed bits to the LSBs of each sample value of the reference picture.

5. The method of claim 2, wherein the bit depth of the reference picture is re-scaled by inserting as many random values as the number of removed bits to the LSBs of each sample value of the reference picture.

6. The method of claim 1, wherein the bit depth of the reconstructed picture is scaled by applying a transform function to each sample value of the reconstructed picture.

7. The method of claim 6, wherein the bit depth of the reconstructed picture is re-scaled by applying an inverse transform function having an inverse relationship with the transform function to each sample value of the reference picture.

8. The method of claim 1, wherein information about a method for scaling/re-scaling the bit depth is predetermined or signaled by an encoder in units of sequences, pictures, slices, or blocks.

9. The method of claim 1, wherein the re-scaling the bit depth re-scales the bit depth of the reference block before interpolation filtering is performed on a reference block designated by motion information of the current block in the reference picture,
wherein the prediction block for the current block is generated on the basis of the reference block the bit depth of which has been re-scaled.

10. The method of claim 1, wherein the re-scaling the bit depth re-scales the bit depth of the reference block after interpolation filtering is performed on a reference block designated by motion information of the current block in the reference picture,
wherein the prediction block for the current block is generated on the basis of a reference block the bit depth of which has been re-scaled.

11. The method of claim 1, wherein the re-scaling the bit depth re-scales the bit depth of the reference block while interpolation filtering is performed on a reference block designated by motion information of the current block in the reference picture,
wherein the prediction block for the current block is generated on the basis of a reference block the bit depth of which has been re-scaled.

12. An apparatus for processing an image on the basis of inter prediction, comprising:
a bit depth scaling unit scaling the bit depth of a reconstructed picture and storing the same in a reference picture buffer;
a bit depth re-scaling unit re-scaling the bit depth of a reference picture of a current block in the reconstructed picture stored in the reference picture buffer; and
a prediction block generating unit generating a prediction block for the current block on the basis of the reference picture, the bit depth of which has been re-scaled.
